(19) United States
(12) Patent Application Publication
(10) Pub. No.: US 2019/0106629 A1
(43) Pub. Date: Apr. 11, 2019

(54) LIQUID CRYSTAL DISPLAY DEVICE

(71) Applicant: SHARP KABUSHIKI KAISHA, Sakai City (JP)

(72) Inventors: MASANOBU MIZUSAKI, Sakai City (JP); HIROSHI TSUCHIYA, Sakai City (JP)

(21) Appl. No.: 16/157,080

(22) Filed: Oct. 10, 2018

(30) Foreign Application Priority Data
Oct. 10, 2017 (JP) 2017-197033

(51) Int. Cl. C09K 19/56; G02F 1/1333; G02F 1/1337; C09K 19/06

(52) U.S. Cl. CPC C09K 19/56; G02F 1/133345; G02F 1/133711; G02F 1/1368; G02F 1/133723; G02F 2001/133397; C09K 19/06

(57) ABSTRACT

The present invention provides a liquid crystal display device capable of reducing a VHR decrease and a residual DC voltage increase after long-term use of the device. The liquid crystal display device includes: a first substrate; a second substrate facing the first substrate; a liquid crystal layer held between the first substrate and the second substrate; and an alignment film disposed on a surface adjacent to the liquid crystal layer of one or both of the first substrate and the second substrate, the one or both of the first substrate and the second substrate with the alignment film disposed thereon including an interlayer insulating film that contains at least one selected from a positive resist and a photoreaction product thereof, the liquid crystal layer containing a liquid crystal material that contains at least one selected from a terphenyl compound and a tetraphenyl compound, the alignment film containing at least one selected from the group consisting of a group represented by the following formula (S-1), a group represented by the following formula (S-2), and a heteroaromatic group.

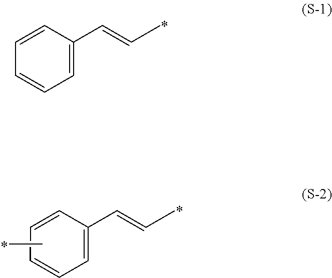

### CROSS-REFERENCE TO RELATED APPLICATIONS

The present application claims priority under 35 U.S.C. § 119 to Japanese Patent Application No. 2017-197033 filed on Oct. 10, 2017, the contents of which are incorporated herein by reference in their entirety.

### BACKGROUND OF THE INVENTION

### Field of the Invention

The present invention relates to liquid crystal display devices. More specifically, the present invention relates to a liquid crystal display device including an alignment film.

### Description of Related Art

Liquid crystal display devices are display devices that utilize a liquid crystal material to provide display. In a typical display mode thereof, a liquid crystal panel enclosing a liquid crystal material between paired substrates is irradiated with light from a backlight, and voltage is applied to the liquid crystal material. The voltage application changes the alignment of a liquid crystal compound, thereby controlling the amount of light transmitted through the liquid crystal panel. A liquid crystal display device includes a pair of substrates, namely a thin-film transistor (TFT) substrate with switching elements and a color filter (CF) substrate disposed to face the TFT substrate, and a liquid crystal layer containing a liquid crystal material between the substrates. Pixel electrodes are formed on the TFT substrate, and a common electrode is formed on the TFT substrate or the CF substrate. Applying variable voltage to the electrodes allows control of the alignment of the liquid crystal compound in the liquid crystal layer. The TFT substrate and the CF substrate are each provided, on its surface adjacent to the liquid crystal layer, with an alignment film which controls the alignment of the liquid crystal compound with no voltage applied.

For example, JP 2016-41683 A discloses an alignment film utilizing a polyamic acid obtained by reacting tetracarboxylic acid dianhydride having at least one triazole ring with a diamine.

### BRIEF SUMMARY OF THE INVENTION

Liquid crystal display devices for vehicles or digital signage are likely to be used at high temperatures in vehicles or outdoors. For this reason, liquid crystal materials used in devices for vehicles or digital signage may be desired to have a nematic-isotropic transition temperature (Tni) as high as, for example, 90° C. or higher. Meanwhile, head mounted displays (HMDs), which are desired to have a high response speed, may have a reduced cell thickness for an increase in response speed. Liquid crystal materials for HMDs may therefore be desired to have high refractive index anisotropy (Δn) such that a sufficient transmittance is achieved even with a small cell thickness. Such a liquid crystal material having a high Tni or a high Δn may be produced by, for example, introducing 5 wt % or more of a terphenyl or tetraphenyl compound, which has a relatively large molecular weight and a low molecular flexibility. Terphenyl compounds and tetraphenyl compounds are likely to absorb light (ultraviolet light), and are therefore likely to undergo an electron transfer reaction to generate radical ions.

The TFT substrate includes an interlayer insulating film between the TFTs and a display portion (pixel electrodes). The interlayer insulating film is, for example, a positive resist mainly containing a polymer, a photoacid generator, and a photosensitizer. The photosensitizer may be a compound containing a naphthoquinone diazide group (naphthoquinone diazide compound; hereinafter, also referred to as NQD) as shown in the reaction scheme in the following formula 1.

When irradiated with light such as ultraviolet light, an NQD unfortunately generates a biradical in an intermediate stage of the reaction and eventually forms a carboxylic acid, as shown in the reaction scheme in the following formula 1.

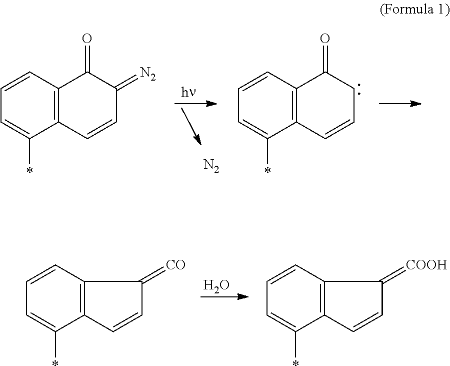

At least a moiety of the NQD contained in the interlayer insulating film remains unreacted. Long-term use of a liquid crystal display device containing such an unreacted moiety of the NQD in the interlayer insulating film may cause the unreacted moiety of the NQD to permeate the electrodes and the alignment film to dissolve directly in the liquid crystal layer. The unreacted moiety of the NQD having dissolved in the liquid crystal layer undergoes the reaction under a small amount of ultraviolet light in the backlight illumination, generating a biradical through the reaction scheme shown in the formula 1. The biradical causes electron transfer as shown in the following formula 2 with a terphenyl compound or a tetraphenyl compound, which are likely to relatively stably incorporate a radical, so that radical ions are formed.

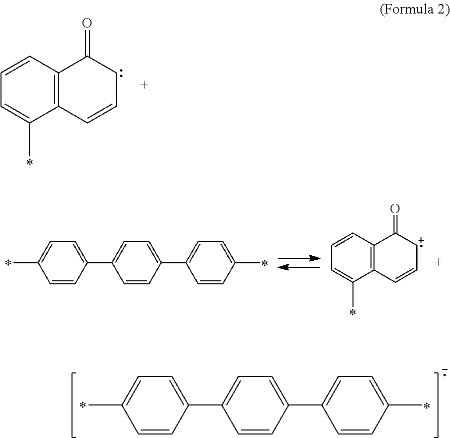

These radical ions formed in the liquid crystal layer causes a decrease in the voltage holding ratio (VHR) and an increase in the residual DC (rDC) voltage during use of the liquid crystal display device, leading to flicker and image sticking. A terphenyl compound and a tetraphenyl compound are contained in both a positive liquid crystal material and a negative liquid crystal material. Yet, negative liquid crystal materials especially easily dissolve NQDs and thus significantly cause flicker and image sticking.

The reason why negative liquid crystal materials more easily dissolve NQDs than positive liquid crystal materials seems to be as follows. An NQD takes in moisture (dissolves in water) and forms a carboxylic acid as shown in the formula 1. This means that NQDs are regarded as having a high solubility in water. As to liquid crystal materials, a negative liquid crystal compound in a negative liquid crystal material contains more —O— (oxygen), —F (fluorine), and —Cl (chlorine) groups having a high polarity than a positive liquid crystal compound in a positive liquid crystal material. The polarity of the negative liquid crystal compound is therefore higher than that of the positive liquid crystal compound, meaning that the negative liquid crystal material is more likely to take in moisture which has polarity. In other words, the negative liquid crystal material takes in a larger amount of moisture than the positive liquid crystal material, so that an NQD is more easily taken into the negative liquid crystal material than into the positive liquid crystal material. The positive liquid crystal compound is a liquid crystal compound having positive anisotropy of dielectric constant, and the positive liquid crystal material is a liquid crystal material containing the positive liquid crystal compound. The negative liquid crystal compound is a liquid crystal compound having negative anisotropy of dielectric constant, and the negative liquid crystal material is a liquid crystal material containing the negative liquid crystal compound.

A liquid crystal material, when containing a terphenyl compound and/or a tetraphenyl compound, thus causes electron transfer as shown in the formula 2 between a biradical product generated upon light application to an NQD and the terphenyl compound and/or the tetraphenyl compound in the liquid crystal material, whereby radical ions are formed in the liquid crystal layer. This may cause flicker due to a VHR decrease and image sticking due to residual DC voltage.

JP 2016-41683 A, however, fails to disclose an interlayer insulating film containing a positive resist, and also fails to consider the issue of the flicker due to a VHR decrease and image sticking due to residual DC voltage in a liquid crystal display device including an interlayer insulating film with a positive resist and a liquid crystal material containing at least one compound selected from a terphenyl compound and a tetraphenyl compound after long-term use.

In response to the above issue, an object of the present invention is to provide a liquid crystal display device capable of reducing a VHR decrease and a residual DC voltage after long-term use of the device.

The present inventors made various studies on a liquid crystal display device capable of reducing the VHR decrease and the residual DC voltage increase after long-term use of the device. The studies found that introducing a group represented by the following formula (S-1) and/or a group represented by the following formula (S-2) into the alignment film causes an electron transfer reaction between a biradical generated by a positive resist (for example, NQD) in the interlayer insulating film and the group represented by the following formula (S-1) and/or the group represented by the following formula (S-2). This can reduce an electron transfer reaction between the biradical and a terphenyl compound and/or a tetraphenyl compound in the liquid crystal layer. The present inventors also found that introducing a heteroaromatic group into the alignment film causes an interaction between the positive resist (for example, NQD) in the interlayer insulating film and the heteroaromatic group, reducing dissolution of an unreacted moiety of the positive resist into the liquid crystal layer through the alignment film. Thereby, the inventors successfully achieved the above object, completing the present invention.

In other words, one aspect of the present invention may be a liquid crystal display device including: a first substrate; a second substrate facing the first substrate; a liquid crystal layer held between the first substrate and the second substrate; and an alignment film disposed on a surface adjacent to the liquid crystal layer of one or both of the first substrate and the second substrate, the one or both of the first substrate and the second substrate with the alignment film disposed thereon including an interlayer insulating film that contains at least one selected from a positive resist and a photoreaction product thereof, the liquid crystal layer containing a liquid crystal material that contains at least one selected from a terphenyl compound and a tetraphenyl compound, the alignment film containing at least one selected from the group consisting of a group represented by the following formula (S-1), a group represented by the following formula (S-2), and a heteroaromatic group:

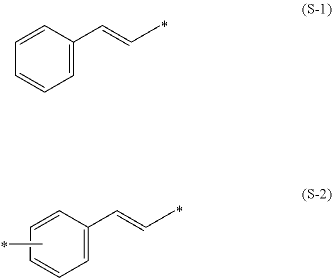

wherein at least one hydrogen atom in the aromatic ring may be replaced by a methyl group, an ethyl group, or a halogen atom, and at least one hydrogen atom in the vinyl group may be replaced by a methyl group or a halogen atom.

The positive resist may contain a naphthoquinone diazide compound.

The liquid crystal material may have a nematic-isotropic transition temperature of 90° C. or higher and 115° C. or lower.

The liquid crystal material may contain at least one selected from compounds represented by the following formulas (A-1a) to (A-1c) and (A-2a) to (A-2g):

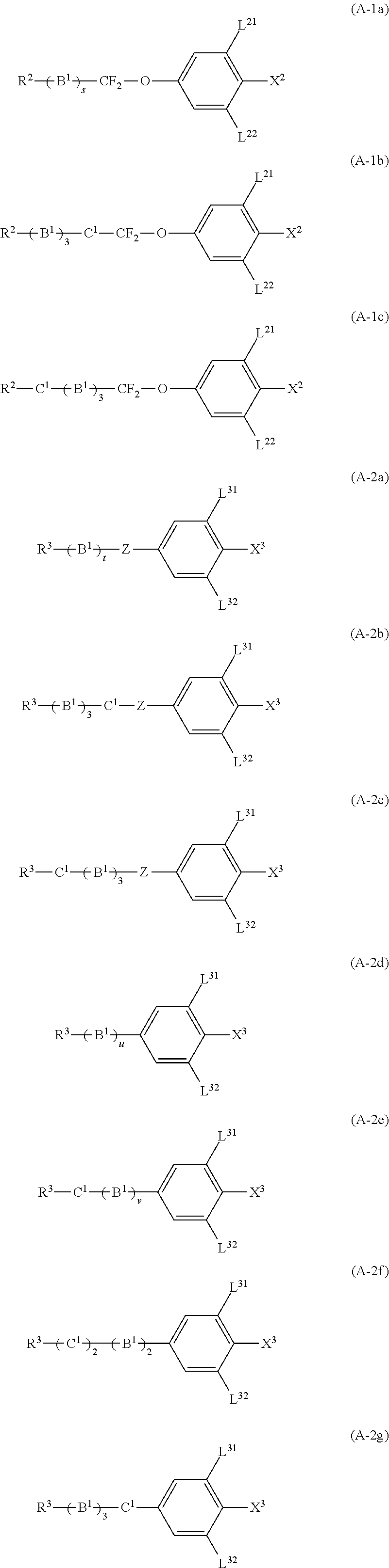

wherein R² and R³ are each independently a C1-C7 alkyl, alkoxy, fluorinated alkyl, or fluorinated alkoxy group, or a C2-C7 alkenyl, alkenyloxy, alkoxyalkyl, or fluorinated alkenyl group; B¹ is any one of groups represented by the following formulas (b11) to (b15); C¹ is any one of groups represented by the following formulas (c11) to (c24); L²¹, L²², L³¹, and L³² are each independently a hydrogen atom or a fluorine atom; X² and X³ are each independently a halogen atom, a C1-C3 halogenated alkyl or alkoxy group, or a C2-C3 halogenated alkenyl or alkenyloxy group; Z is —CH₂CH₂—, —CF₂CF₂—, —COO—, trans-CH═CH—, trans-CF═CF—, or —CH₂O—; s and t are each independently 3 or 4; and u and v are each independently 2 or 3,

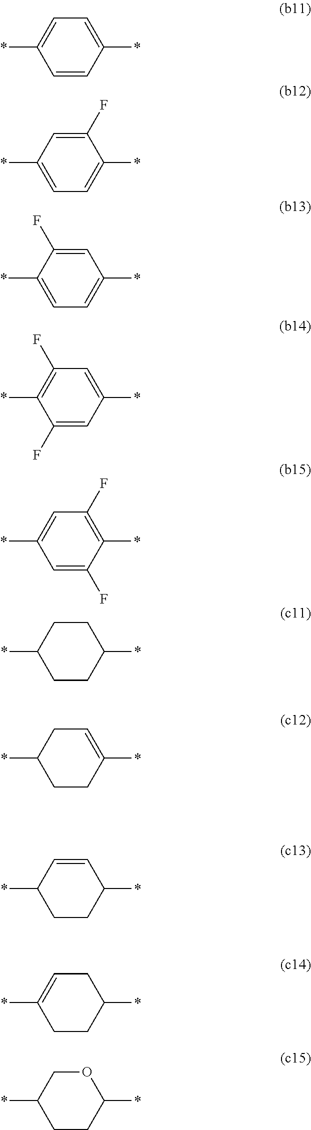

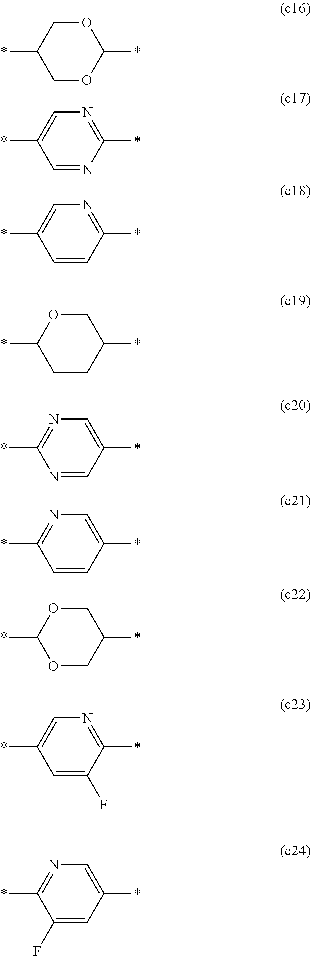

wherein * is a binding site.

The alignment film may contain at least one selected from a cinnamate group and a chalcone group.

The heteroaromatic group may contain a heterocycle that contains a secondary amino group.

The heteroaromatic group may be at least one selected from the group consisting of an indole group, a benzimidazole group, a purine group, a phenoxazine group, and a phenothiazine group.

The alignment film may have at least one polymer main chain structure selected from the group consisting of a polyamic acid structure, a polyimide structure, a polysiloxane structure, and a polyvinyl structure.

The present invention can provide a liquid crystal display device capable of reducing the VHR decrease and the residual DC voltage increase after long-term use of the device.

### BRIEF DESCRIPTION OF THE DRAWINGS

FIG. 1 is a schematic cross-sectional view of an exemplary liquid crystal display device of Embodiment 1, which is a UV2A-mode liquid crystal display device.

FIG. 2 is a schematic cross-sectional view of another exemplary liquid crystal display device of Embodiment 1, which is an FFS-mode liquid crystal display device.

### DETAILED DESCRIPTION OF THE INVENTION

The present invention is described in more detail below based on an embodiment with reference to the drawings. The embodiment, however, is not intended to limit the scope of the present invention. The configurations of the embodiment may appropriately be combined or modified within the spirit of the present invention.

### Embodiment 1

Liquid crystal display devices are in a display (liquid crystal alignment) mode such as the twisted nematic (TN) mode in which a liquid crystal compound having positive anisotropy of dielectric constant is aligned such that the alignment is twisted by 90° as viewed from the direction normal to the substrates, or the vertical alignment (VA) mode in which a liquid crystal compound having negative anisotropy of dielectric constant is aligned in the direction perpendicular to the substrate surfaces. For easy achievement of wide viewing angle characteristics, the display mode may be, for example, the in-plane switching (IPS) mode or the fringe field switching (FFS) mode in each of which a liquid crystal compound having positive or negative anisotropy of dielectric constant is aligned in the direction parallel to the substrate surfaces so that a transverse electric field is generated in the liquid crystal layer. The present embodiment may employ any display mode. The present embodiment herein is described by taking as examples an FFS-mode liquid crystal display device and a VA-mode liquid crystal display device, particularly an ultra-violet induced multi-domain vertical alignment (UV2A)-mode liquid crystal display device in which a first substrate and a second substrate facing each other control the alignment of a liquid crystal compound at azimuths shifted from each other by 90°.

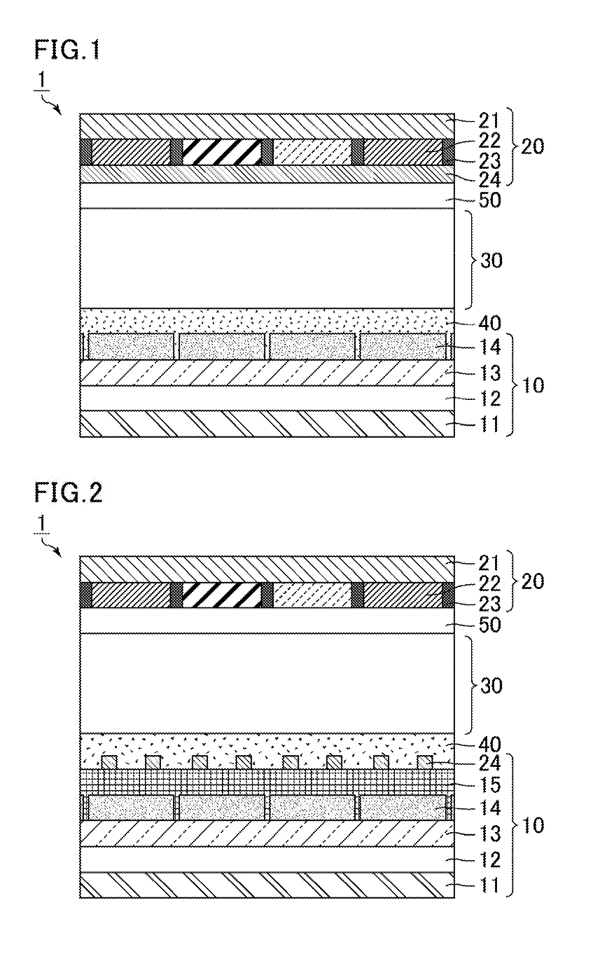

FIG. 1 is a schematic cross-sectional view of an exemplary liquid crystal display device of Embodiment 1, which is a UV2A-mode liquid crystal display device. FIG. 2 is a schematic cross-sectional view of another exemplary liquid crystal display device of Embodiment 1, which is an FFS-mode liquid crystal display device. An UV2A-mode liquid crystal display device 1 shown in FIG. 1 and an FFS-mode liquid crystal display device 1 shown in FIG. 2 have the same configuration, except that the electrode structures are different.

As shown in FIG. 1 and FIG. 2, the liquid crystal display devices 1 of the present embodiment each include a first substrate 10 including an interlayer insulating film 13; a second substrate 20 facing the first substrate 10; and a liquid crystal layer 30 held between the first substrate 10 and the second substrate 20. The interlayer insulating film 13 contains at least one selected from a positive resist and a photoreaction product thereof. The liquid crystal layer 30 contains a liquid crystal material containing at least one compound selected from a terphenyl compound and a tetraphenyl compound. The terphenyl compound contains a group obtained by removing one or more hydrogen atoms from a paraterphenyl, i.e., p-terphenyl. The tetraphenyl compound is also referred to as a quaterphenyl compound, and contains a group obtained by removing one or more hydrogen atoms from a tetraphenyl (quaterphenyl) in which the two central benzene rings are each bonded directly to a neighboring benzene ring at the para position. A tetraphenyl in which the two central benzene rings are each bonded directly to a neighboring benzene ring at the para position is also called a paratetraphenyl.

Between the first substrate 10 and the liquid crystal layer 30 and between the second substrate 20 and the liquid crystal layer 30 are formed alignment films 40 and 50, respectively. The alignment film 40 disposed on the first substrate 10 including the interlayer insulating film 13 contains one polymer or two or more polymers. At least one of the polymers includes at least one selected from the group consisting of a group represented by the following formula (S-1), a group represented by the following formula (S-2), and a heteroaromatic group. In other words, the alignment film 40 disposed on the first substrate 10 including the interlayer insulating film 13 contains at least one selected from the group consisting of a group represented by the following formula (S-1), a group represented by the following formula (S-2), and a heteroaromatic group.

The at least one selected from the group consisting of a group represented by the following formula (S-1), a group represented by the following formula (S-2), and a heteroaromatic group is also referred to simply as a “specific group” hereinbelow. A polymer in an alignment film is also referred to as an alignment film polymer. In other words, an alignment film polymer containing at least one selected from the group consisting of a group represented by the following formula (S-1), a group represented by the following formula (S-2), and a heteroaromatic group among alignment film polymers is also referred to as an alignment film polymer containing a specific group. An alignment film polymer containing none of a group represented by the following formula (S-1), a group represented by the following formula (S-2), and a heteroaromatic group is also referred to as an alignment film polymer containing no specific group.

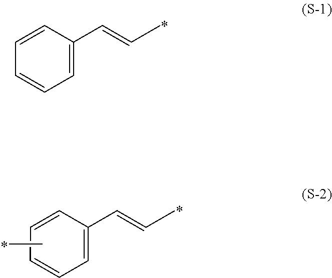

In each of the formulas (S-1) and (S-2), at least one hydrogen atom in the aromatic ring may be replaced by a methyl group, an ethyl group, or a halogen atom; at least one hydrogen atom in the vinyl group may be replaced by a methyl group or a halogen atom. In the case where at least one hydrogen atom in the aromatic ring is replaced by a halogen atom, the halogen atom is preferably a fluorine atom or a chlorine atom. In the case where at least one hydrogen atom in the vinyl group is replaced by a halogen atom, the halogen atom is preferably a fluorine atom or a chlorine atom.

Long-term (e.g., 1000 hours) use of a liquid crystal display device including an interlayer insulating film with an NQD may cause an unreacted moiety of the NQD to permeate the electrodes and the alignment film to dissolve in the liquid crystal layer. Application of light such as ultraviolet light to the NQD having dissolved in the liquid crystal layer causes a reaction shown in the formula 1, forming a biradical. The biradical causes an electron transfer reaction with at least one compound selected from the terphenyl compound and the tetraphenyl compound in the liquid crystal layer, forming radical ions. Hence, long-term use of a liquid crystal display device including an interlayer insulating film with an NQD may cause flicker due to a VHR decrease and image sticking due to residual DC voltage.

In the present embodiment, a group represented by the formula (S-1) and/or a group represented by the formula (S-2) may be introduced into the alignment film 40 disposed on the first substrate 10 including the interlayer insulating film 13. This causes an electron transfer reaction as shown in the reaction scheme in the following formula 3 between the group represented by the formula (S-1) and/or the group represented by the formula (S-2) and a biradical generated through the reaction scheme of the formula 1 to generate radical ions inside the alignment film 40. The reaction reduces an electron transfer reaction between the terphenyl compound and/or the tetraphenyl compound in the liquid crystal layer 30 and the biradical. Radical ions generated inside the alignment film 40 are not, or substantially not, diffused to the liquid crystal layer 30. This mechanism can reduce the amount of radical ions to be generated in the liquid crystal layer 30, thereby reducing the VHR decrease and the rDC voltage increase with time due to the mobility (e.g., diffusibility) of the radical ions in the liquid crystal layer 30 even when the liquid crystal display device 1 is used for a long period of time. The liquid crystal display device 1 therefore can reduce the VHR decrease and the residual DC voltage increase due to long-term use of the device, reducing flicker due to the VHR decrease and image sticking due to the residual DC voltage.

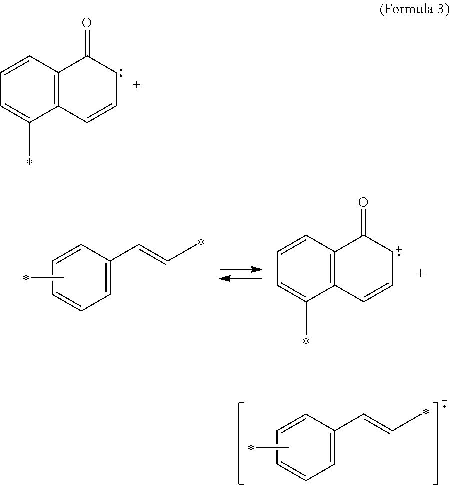

Also in the present embodiment, a heteroaromatic group may be introduced into the alignment film 40 disposed on the first substrate 10 including the interlayer insulating film 13. This causes the Van der Waals interaction between the heteroaromatic group and the NQD (more specifically, interaction between the aromatic ring in the heteroaromatic group and the aromatic ring in the NQD), reducing dissolution of an unreacted moiety of the NQD into the liquid crystal layer 30 through the alignment film 40. This mechanism can reduce the amount of radical ions to be generated in the liquid crystal layer 30 even when the liquid crystal display device 1 is used for a long period of time. The liquid crystal display device 1 therefore can reduce the VHR decrease and the residual DC voltage increase due to long-term use of the device, reducing flicker due to the VHR decrease and image sticking due to the residual DC voltage. The heteroaromatic group as used herein means a group that is obtained by removing one or more hydrogen atoms from a condensed ring compound with at least one aromatic ring, and contains at least one heterocycle. The condensed ring compound may have: (1) aromatic rings alone; or (2) aromatic ring(s) and non-aromatic ring(s). The case (1) includes the following cases: (a) the compound has two or more aromatic heterocycles alone (e.g., purine); and (b) the compound has one or more aromatic heterocycles and one or more aromatic hydrocarbons (e.g., indole, benzimidazole). The case (2) includes the following cases: (a) the compound has one or more non-aromatic heterocycles and one or more aromatic hydrocarbons (e.g., phenoxazine, phenothiazine); (b) the compound has one or more non-aromatic heterocycles and one or more aromatic heterocycles; and (c) the compound has one or more non-aromatic heterocycles, one or more aromatic heterocycles, and one or more aromatic hydrocarbons. The aromatic hydrocarbons may each be a single ring (e.g., benzene ring) or a condensed ring.

The alignment film 40 disposed on the first substrate 10 including the interlayer insulating film 13 contains, as described above, at least one selected from the group consisting of a group represented by the formula (S-1), a group represented by the formula (S-2), and a heteroaromatic group. This structure in the present embodiment therefore can reduce the amount of radical ions to be generated in the liquid crystal layer 30 after long-term use of the liquid crystal display device 1 even when the positive resist in the interlayer insulating film 13 contains an NQD. The liquid crystal display device 1 therefore can reduce the VHR decrease and the residual DC voltage increase due to long-term use of the device, reducing flicker due to the VHR decrease and image sticking due to the residual DC voltage. The VHR decrease and the residual DC voltage increase are likely to occur especially after long-term use at high temperatures. The present embodiment enables effective reduction of the VHR decrease and the residual DC voltage increase even in such a case. The liquid crystal display device 1 is described in detail below.

The first substrate 10 shown in FIG. 1 and FIG. 2 includes, in the given order toward the liquid crystal layer 30, an insulating substrate 11 which is a transparent substrate (e.g., glass substrate), a TFT layer 12, the interlayer insulating film 13, and planar pixel electrodes 14 disposed in the respective pixels. The first substrate 10 is also referred to as a TFT substrate.

The second substrate 20 includes, in the given order toward the liquid crystal layer 30, an insulating substrate 21 which is a transparent substrate (e.g., glass substrate), a color filter layer 22 and a black matrix layer 23, and a common electrode 24. The second substrate 20 is also referred to as a CF substrate.

On the surface of the first substrate 10 remote from the liquid crystal layer 30 is disposed a first polarizing plate (not shown). On the surface of the second substrate 20 remote from the liquid crystal layer 30 is disposed a second polarizing plate (not shown). The first polarizing plate and the second polarizing plate are disposed such that their polarization axes are in the crossed Nicols. A backlight (not shown) is disposed behind the second substrate 20 (at the side remote from the liquid crystal layer 30).

The TFT layer 12 includes scanning lines, data lines, and TFTs connected to the respective scanning lines and the respective data lines.

The interlayer insulating film 13 insulates the TFT layer 12 from the pixel electrodes 14. The interlayer insulating film 13 is also simply referred to as an insulating film and is formed of, for example, a positive resist that is patterned by photolithography to allow contact between the TFTs in the TFT layer 12 and the corresponding pixel electrodes 14. The positive resist contains, for example, an insulating polymer (e.g., epoxy polymer), a novolac resin, a photoacid generator, and an NQD which is a photosensitizer for a positive resist. The interlayer insulating film 13 may have any other function(s). The interlayer insulating film 13 is preferably disposed in the entire display region of the liquid crystal display device 1, particularly in at least the opening in each pixel.

The epoxy polymer (epoxy resin) may be any cured product of a prepolymer having an epoxy group. The prepolymer having an epoxy group can be one usually used in the field of positive resists. The prepolymer having an epoxy group can be, for example, a compound represented by the following formula (E).

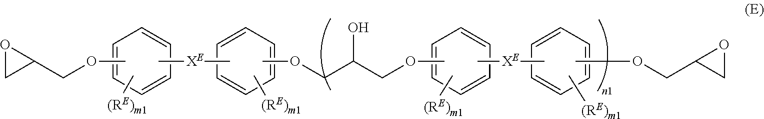

In the formula (E), R^{E}s are each a —OH group, a halogen atom, a C1-C12 saturated alkyl or saturated alkoxy group, or a C2-C12 unsaturated alkyl or unsaturated alkoxy group; X^{E}s are each —CH₂—, —CH(CH₃)—, or —C(CH₃)₂—; m₁s are each an integer of 1 to 4; and n₁ is an integer of 1 to 6. In the formula (E), R^{E}s and X^{E}s may each include one group or two or more different groups.

The novolac resin may be one usually used in the field of positive resists. The novolac resin may be any novolac resin, and is preferably one obtained by causing condensation reaction between 1 mol of a phenol and 0.5 to 1.0 mol of a condensation agent such as an aldehyde in the presence of an acid catalyst.

Examples of the phenol include phenol; cresols such as o-cresol, m-cresol, and p-cresol; xylenols such as 2,3-xylenol, 2,4-xylenol, 2,5-xylenol, 2,6-xylenol, 3,4-xylenol, and 3,5-xylenol; ethylphenols such as o-ethylphenol, m-ethylphenol, and p-ethylphenol; alkyl phenols such as 2-isopropylphenol, 3-isopropylphenol, 4-isopropylphenol, o-butylphenol, m-butylphenol, p-butylphenol, and p-tert-butylphenol; trialkyl phenols such as 2,3,5-trimethylphenol and 3,4,5-trimethylphenol; polyhydric phenols such as resorcinol, catechol, hydroquinone, hydroquinone monomethyl ether, pyrogallol, and phloroglucinol; alkyl polyhydric phenols such as alkylresorcinol, alkyl catechol, and alkyl hydroquinone (all these alkyl groups are C1-C4 ones), α-naphthol, β-naphthol, hydroxy diphenyl, and bisphenol A. These phenols may be used alone or in combination with each other.

Examples of the condensation agent include aldehydes and ketones. Preferred are aldehydes, particularly formaldehyde and paraformaldehyde.

Examples of the novolac resin include a compound represented by the following formula (NB).

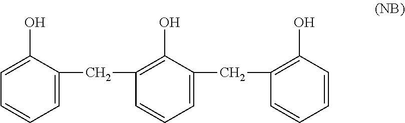 [SMILES: Oc1ccccc1Cc1cccc(Cc2ccccc2O)c1O]

The photoacid generator is used as a cationic polymerization initiator for the epoxy polymer. The photoacid generator may be any one usually used in the field of positive resists. For example, a sulfonium salt (IRGACURE® 290, available from BASF) represented by the following formula (LA) can be used.

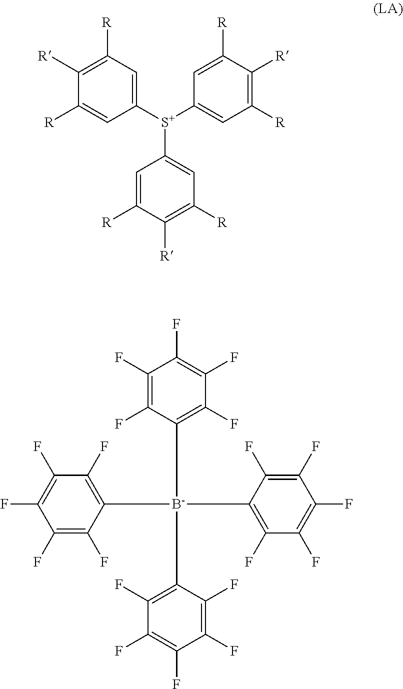

In the formula (LA), Rs are each a methyl, ethyl, n-propyl, isopropyl, n-butyl, or isobutyl group, and R's are each a methyl, ethyl, n-propyl, isopropyl, n-butyl, or isobutyl group.

The interlayer insulating film 13 preferably contains at least one selected from a positive resist and a photoreaction product thereof. An interlayer insulating film 13 containing a positive resist and no photoreaction product thereof is, for example, an interlayer insulating film 13 in which all the photosensitive moieties (e.g., naphthoquinone diazide groups in the NQD) in the positive resist remain unreacted. An interlayer insulating film 13 containing no positive resist but contains a photoreaction product thereof is, for example, an interlayer insulating film 13 in which all the photosensitive moieties in the positive resist are converted into a photoreaction product by photoirradiation and remain in the interlayer insulating film 13. An interlayer insulating film 13 containing both a positive resist and a photoreaction product is, for example, an interlayer insulating film 13 in which some of the photosensitive moieties in the positive resist are converted into a photoreaction product by photoirradiation, and both unreacted moieties of the positive resist and the photoreaction product are contained in the interlayer insulating film 13. In the liquid crystal display device 1, a photoreaction product of the positive resist seems to be easily generated by photoirradiation in the openings with no light-shielding member (e.g., black matrix) formed, while the positive resist seems to easily remain unreacted in the light-shielding regions with a light-shielding member formed.

The positive resist preferably contains a naphthoquinone diazide compound (NQD). An NQD is a highly reactive positive resist compound that has a naphthoquinone diazide group (1,2-naphthoquinone diazide group) which is a photosensitive moiety. An NQD therefore can reduce defects due to contact failure between the TFTs and the corresponding pixel electrodes 14 in the process of patterning the interlayer insulating film 13 and bringing the TFTs and the corresponding pixel electrodes 14 into contact with each other.

The NQD is preferably a compound having a naphthoquinone diazide group represented by the following formula (N1).

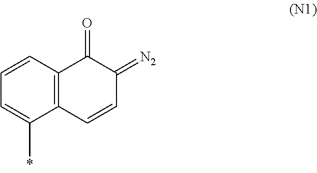

Examples of the NQD include compounds such as compounds obtained by replacing at least one hydroxy group in a polyhydric phenol by a group having the naphthoquinone diazide group; and polymers having the naphthoquinone diazide group. The polymer may be any polymer such as a network polymer. In the present embodiment, the NQD is supposed to be a material different from a novolac resin. The NQD, however, may be a compound obtained by replacing some phenolic hydroxy groups in a novolac resin by groups having a naphthoquinone diazide group, i.e., a novolac resin having a naphthoquinone diazide group. In this case, the positive resist may not contain a novolac resin separately from the NQD.

The NQD is more preferably a compound having a group represented by the following formula (N2) (1,2-naphthoquinone diazide-5-sulfonyl group) which includes the naphthoquinone diazide group represented by the formula (N1).

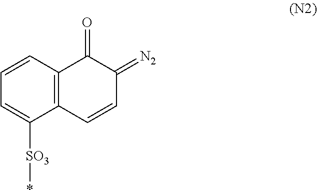

Application of light such as ultraviolet light to the NQD generates a biradical in an intermediate stage of the reaction as shown by the reaction scheme of the formula 1, eventually forming a carboxylic acid (indene carboxylic acid).

As shown in FIG. 1, the UV2A-mode liquid crystal display device 1 can generate an electric field in the liquid crystal layer 30 by applying voltage between the pixel electrodes 14 and the common electrode 24 constituting the paired electrodes. Hence, controlling the voltage applied between the pixel electrodes 14 and the common electrode 24 allows control of the alignment of the liquid crystal compound in the liquid crystal layer 30.

As shown in FIG. 2, the first substrate 10 in the FFS-mode liquid crystal display device 1 includes, in the given order toward the liquid crystal layer 30, the planar pixel electrodes 14 disposed in the respective pixels, the second insulating film 15, and a comb-teeth common electrode 24 provided with slits. The positions of the pixel electrodes 14 and the common electrode 24 may be interchanged such that comb-teeth pixel electrodes 14 provided with slits are formed in the respective pixels between a planar common electrode 24 and the liquid crystal layer 30. In the FFS-mode liquid crystal display device 1 shown in FIG. 2, the common electrode 24 is disposed on the pixel electrodes 14 with the second insulating film 15 in between. The second insulating film 15 may be, for example, an inorganic film (relative permittivity ε=5 to 7) such as a silicon nitride (SiN_{X}) film or a silicon oxide (SiO₂) film, or a stack of such films.

The pixel electrodes 14 and the common electrode 24 shown in FIG. 1 and FIG. 2 are formed of, for example, indium tin oxide (ITO) or indium zinc oxide (IZO).

The color filter layer 22 shown in FIG. 1 and FIG. 2 is one usually used in the field of liquid crystal display devices and includes color filters of multiple colors. The color filter layer 22 in the present embodiment consists of red color filters, green color filters, and blue color filters, but the color filter layer can further include color filters other than the above color filters, such as yellow color filters. The black matrix layer 23 is one usually used in the field of liquid crystal display devices, and has a function of blocking light from the backlight disposed in the liquid crystal display device 1 and external light.

The liquid crystal layer 30 contains a liquid crystal material containing at least one selected from a terphenyl compound and a tetraphenyl compound. These compounds can increase the nematic-isotropic transition temperature (Tni) of the liquid crystal material or increase the refractive index anisotropy (Δn) of the material. A terphenyl compound and a tetraphenyl compound each can independently exhibit liquid crystal properties, and are also called a terphenyl liquid crystal compound and a tetraphenyl liquid crystal compound, respectively. The liquid crystal material is only required to contain at least one selected from a terphenyl compound and a tetraphenyl compound, and may appropriately contain any other compound (e.g., liquid crystal compound) suitable for the display mode (UV2A mode, FFS mode, or any other mode) of the liquid crystal display device 1. The anisotropy of dielectric constant of the liquid crystal material may be positive or negative. The preferred range of the anisotropy of dielectric constant varies depending on the use. For example, the absolute value of the anisotropy of dielectric constant of the liquid crystal material is 1.5 to 10. The present embodiment can effectively reduce the VHR decrease and the residual DC voltage increase even in the case of utilizing a liquid crystal material having negative anisotropy of dielectric constant which causes flicker due to a VHR decrease and image sticking due to residual DC voltage in a more significant manner. The present embodiment is therefore particularly suitable for the case of utilizing a liquid crystal material having negative anisotropy of dielectric constant.

The total amount of the terphenyl compound and the tetraphenyl compound in the whole liquid crystal material is preferably 0.5 wt % or more and 20 wt % or less, more preferably 1 wt % or more and 10 wt % or less. Such a liquid crystal material can have a high Tni and a high Δn. If the total amount of the terphenyl compound and the tetraphenyl compound is more than 20 wt %, the liquid crystal material may have a high rotational viscosity, exhibiting low response performance.

In the case where the liquid crystal material contains both the terphenyl compound and the tetraphenyl compound, the ratio by weight of the terphenyl liquid crystal compound to the tetraphenyl compound is preferably 1 or higher and 20 or lower. If the ratio by weight is lower than 1, the liquid crystal material may have a high rotational viscosity, exhibiting low response performance. In contrast, if the ratio by weight is higher than 20, the effect of increasing the Tni and Δn may be small.

The liquid crystal material preferably has a Tni of 90° C. or higher and 115° C. or lower, more preferably 95° C. or higher and 110° C. or lower. If having a Tni of lower than 90° C., the liquid crystal material tends to transform into an isotropic phase, and the phase transition may cause display defects in liquid crystal display devices for in-vehicle or digital signage applications which are used at high temperatures. In contrast, if having a Tni of higher than 115° C., the liquid crystal material may exhibit low response performance. The Tni of the liquid crystal material can be determined directly using a temperature controlling device (e.g., one available from Mettler Toledo) or by differential scanning calorimetry (DSC).

The liquid crystal material preferably has a Δn of 0.09 or higher and 0.25 or lower, more preferably 0.12 or higher and 0.16 or lower. If the liquid crystal material has a Δn of lower than 0.09, the cell thickness may need to be increased for a sufficient transmittance, which may deteriorate the response performance. In contrast, if the liquid crystal material has a Δn of higher than 0.25, the scattering of the liquid crystal material may increase, and thereby the contrast ratio may decrease. The Δn of the liquid crystal material can be measured using an Abbe's refractometer.

The terphenyl compound and the tetraphenyl compound are not particularly limited as long as they contain a group obtained by removing one or more hydrogen atoms from a terphenyl and a group obtained by removing one or more hydrogen atoms from a tetraphenyl (quaterphenyl), respectively. The liquid crystal material preferably contains at least one compound represented by any one of the following formulas (A-1a) to (A-1c) and (A-2a) to (A-2g). In other words, the liquid crystal material preferably contains at least one compound selected from the group consisting of compounds represented by the following formulas (A-1a) to (A-1c) and (A-2a) to (A-2g). Such a liquid crystal material can have a high Δn and a low rotational viscosity.

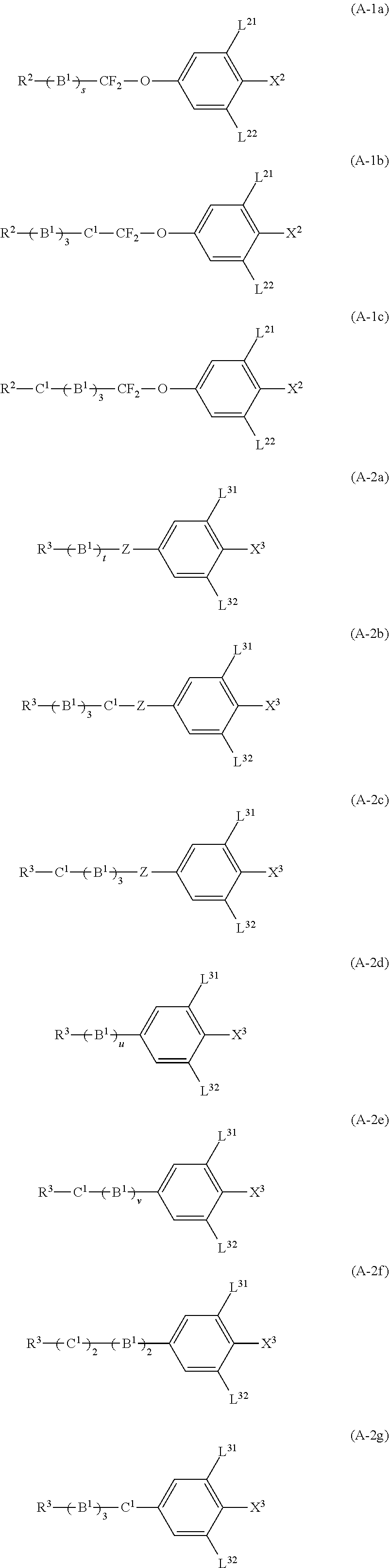

In the formulas (A-1a) to (A-1c) and (A-2a) to (A-2g), R² and R³ are each independently a C1-C7 alkyl, alkoxy, fluorinated alkyl, or fluorinated alkoxy group, or a C2-C7 alkenyl, alkenyloxy, alkoxyalkyl, or fluorinated alkenyl group; B¹ is any one of groups represented by the following formulas (b11) to (b15); C¹ is any one of groups represented by the following formulas (c11) to (c24); L²¹, L²², L³¹, and L³² are each independently a hydrogen atom or a fluorine atom; X² and X³ are each independently a halogen atom, a C1-C3 halogenated alkyl or alkoxy group, or a C2-C3 halogenated alkenyl or alkenyloxy group; Z is —CH₂CH₂—, —CF₂CF₂—, —COO—, trans-CH═CH—, trans-CF═CF—, or —CH₂O—; s and t are each independently 3 or 4; and u and v are each independently 2 or 3,

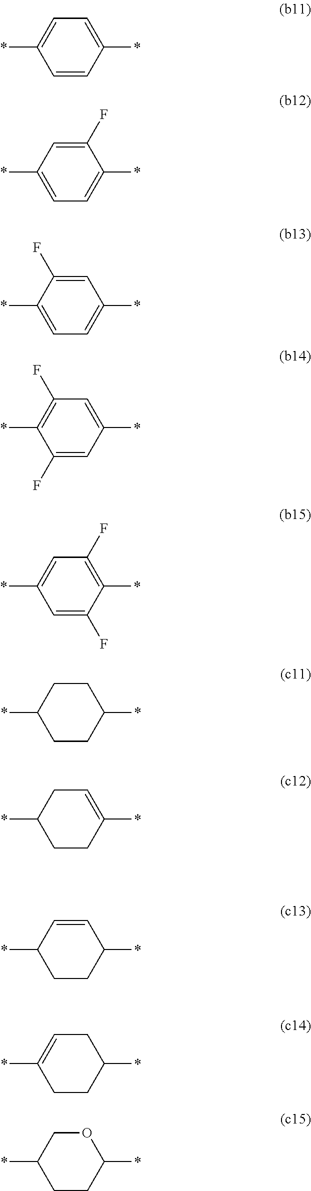

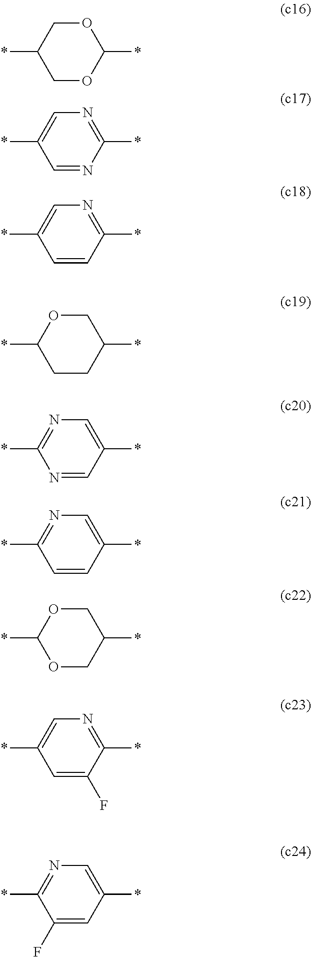

wherein * is a binding site.

In the formulas (A-1a) to (A-1c) and (A-2a) to (A-2g), B¹ is any one of the groups represented by the formulas (b11) to (b15), preferably a group represented by the formula (b11), (b12), (b13) or (b15). A plurality of B¹s are present in each of the formulas (A-1a) to (A-1c) and (A-2a) to (A-2g), and B¹s may be the same as each other or one or more of them may be different from the others.

In the formulas (A-1a) to (A-1c) and (A-2a) to (A-2g), C¹ is any one of the groups represented by the formulas (c11) to (c24), preferably a group represented by the formula (c11), (c15), (c16), or (c17). Two C¹s are present in the formula (A-2f), and C¹s may be the same as or different from each other.

In the formulas (A-1a) to (A-1c) and (A-2a) to (A-2g), at least one selected from L²¹ and L³¹ is preferably a fluorine atom. In the formulas (A-1a) to (A-1c) and (A-2a) to (A-2g), X² and X³ are preferably each independently a fluorine atom, a chlorine atom, —OCF₃, or —CF₃, more preferably a fluorine atom, a chlorine atom, or —OCF₃.

In the formulas (A-1a) to (A-1c) and (A-2a) to (A-2g), Z is preferably —CH₂CH₂—, —COO—, or trans-CH═CH—, more preferably —COO— or trans-CH═CH—. In the formula (A-1a), s is preferably 3. In the formula (A-2a), t is preferably 3. In the formula (A-2d), u is preferably 2. In the formula (A-2e), v is preferably 2.

The liquid crystal material preferably contains at least one compound selected from the compounds represented by the following formulas (A-1-1) to (A-1-3).

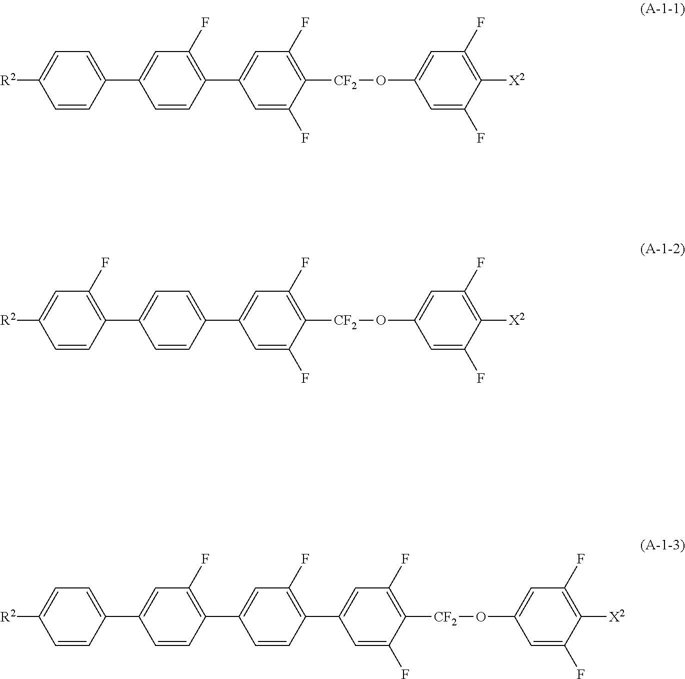

R² in the formulas (A-1-1) to (A-1-3) and the preferred range thereof are the same as R² in the formulas (A-1a) to (A-1c) and the preferred range thereof. X² in the formulas (A-1-1) to (A-1-3) and the preferred range thereof are the same as X² in the formulas (A-1a) to (A-1c) and the preferred range thereof.

X² in the formulas (A-1-1) to (A-1-3) is still more preferably a fluorine atom.

The liquid crystal material more preferably contains at least one compound selected from the compounds represented by the following formulas (A-2-1) to (A-2-10).

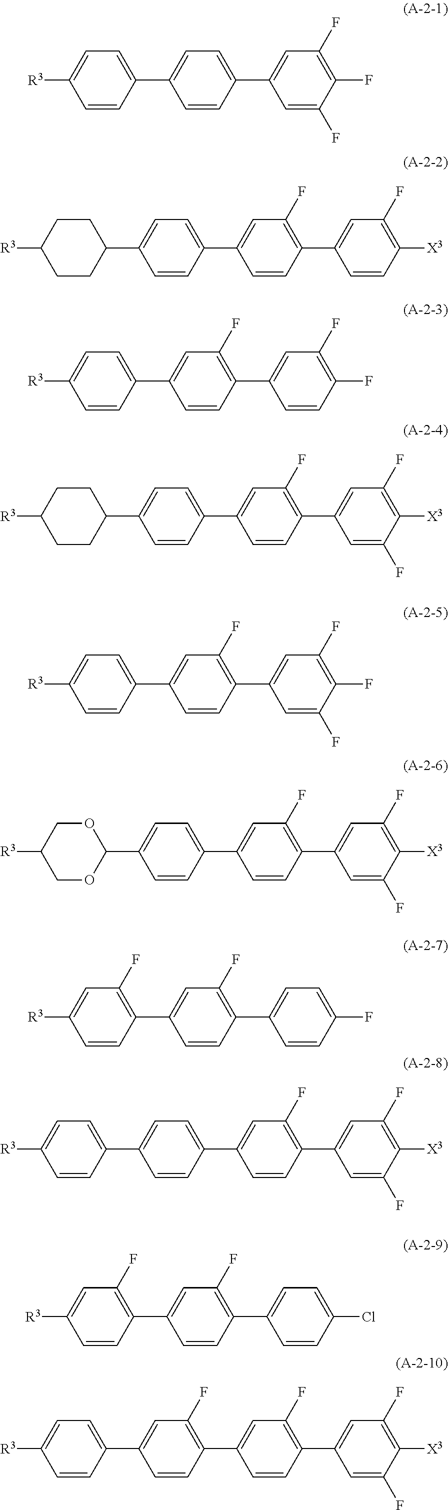

R³ in the formulas (A-2-1) to (A-2-10) and the preferred range thereof are the same as R³ in the formulas (A-2a) to (A-2g) and the preferred range thereof. X³ in the formulas (A-2-1) to (A-2-10) and the preferred range thereof are the same as X³ in the formulas (A-2a) to (A-2g) and the preferred range thereof.

X³ in the formulas (A-2-1) to (A-2-10) is still more preferably a fluorine atom.

The liquid crystal material may contain at least one compound selected from the compounds represented by the following formulas (A-3) and (A-4). This structure is also one of preferred structures.

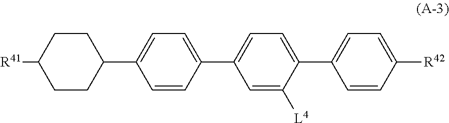

In the formula (A-3), R⁴¹ and R⁴² are each independently a C1-C7 alkyl, alkoxy, fluorinated alkyl, or fluorinated alkoxy group, or a C2-C7 alkenyl, alkenyloxy, alkoxyalkyl, or fluorinated alkenyl group; and L⁴ is a hydrogen atom or a fluorine atom.

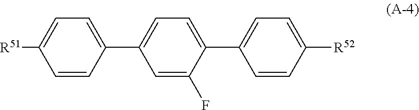

In the formula (A-4), R⁵¹ and R⁵² are each independently a C1-C7 alkyl, alkoxy, fluorinated alkyl, or fluorinated alkoxy group, or a C2-C7 alkenyl, alkenyloxy, alkoxyalkyl, or fluorinated alkenyl group.

In the formula (A-4), R⁵¹ is preferably an alkyl group. In the formula (A-4), R⁵² is preferably an alkyl or alkenyl group, more preferably —CH═CH₂, —(CH₂)₂—CH═CH₂, or —(CH₂)₂—CH═CH—CH₃.

Specific examples of the terphenyl compound and the tetraphenyl compound include compounds represented by the following formulas (AE1) to (AE22).

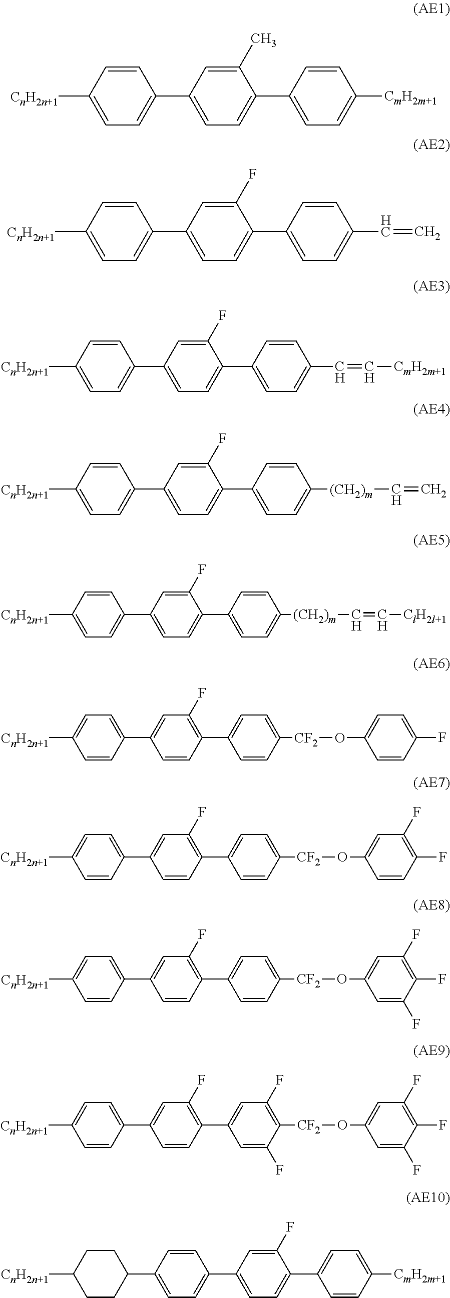

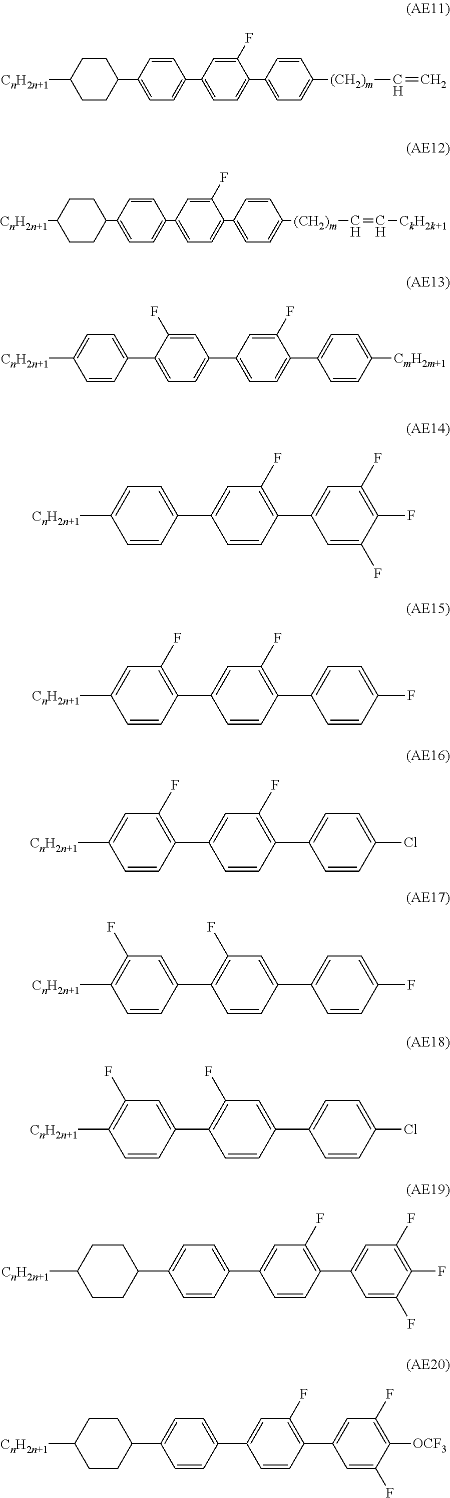

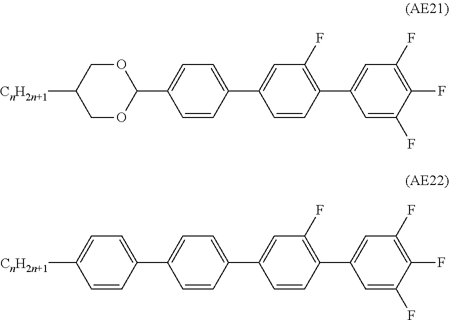

In the formulas (AE1) to (AE22), m, n, and k are each independently an integer of 1 to 8.

The alignment films 40 and 50 have the function of controlling the alignment of the liquid crystal compound in the liquid crystal layer 30 held between the first substrate 10 and the second substrate 20 in the liquid crystal display device 1. When the voltage applied to the liquid crystal layer 30 is less than the threshold voltage (including no voltage application), the alignment of the liquid crystal compound in the liquid crystal layer 30 is mainly controlled by the function of the alignment films 40 and 50. In this state (hereinafter, also referred to as an initial alignment state), the angle formed by the major axis of a liquid crystal compound and the surface of the first substrate 10 or the second substrate 20 is called a “pre-tilt angle”. The “pre-tilt angle” as used herein means the angle of inclination of a liquid crystal compound from the direction parallel to the substrate surface, with the angle parallel to the substrate surface being 0° and the angle of the direction normal to the substrate surface being 90°.

The alignment films 40 and 50 may align the liquid crystal compound in the liquid crystal layer 30 in a direction substantially perpendicular thereto (may be vertical alignment films) or may align the liquid crystal compound in a direction substantially parallel thereto (may be horizontal alignment films). For the “substantially vertical” alignment by the vertical alignment films, the pre-tilt angle is preferably 85° or greater and 90° or smaller. For the “substantially horizontal” alignment by the horizontal alignment films, the pre-tilt angle is preferably 0° or greater and 5° or smaller.

The alignment films 40 and 50 may or may not be subjected to alignment treatment. The alignment treatment method in the case of subjecting the alignment films 40 and 50 may be any method such as rubbing treatment or photoalignment treatment.

The rubbing treatment is a method that rotates a roller wrapped with cloth (e.g., nylon cloth) while pressing under a constant pressure the roller against the first substrate 10 and the second substrate 20 on which the respective alignment films 40 and 50 are formed, thereby rubbing the surfaces of the alignment films 40 and 50 in a certain direction.

The photoalignment treatment is a method that irradiates the alignment films 40 and 50 with linearly polarized ultraviolet light to selectively alter the structures in the polarization direction of the alignment films 40 and 50, thereby making the alignment films 40 and 50 anisotropic and providing an alignment azimuth to the liquid crystal compound. The alignment films 40 and 50 in this case are formed of a material exhibiting photoalignment properties, and are also called photoalignment films. The material exhibiting photoalignment properties encompasses general materials that undergo a structural change when irradiated with light (electromagnetic waves) such as ultraviolet light or visible light, and thereby exhibit an ability (alignment controlling force) of controlling the alignment of the nearby liquid crystal compound or change the alignment controlling force level and/or direction. Examples of the material exhibiting photoalignment properties include those having a photoreactive moiety (photoalignment functional group) that undergoes dimerization (formation of dimers), isomerization, photo-Fries rearrangement, or decomposition when irradiated with light.

Examples of the photoalignment functional group that undergoes dimerization or isomerization when irradiated with light include cinnamate, chalcone, coumarin, and stilbene groups. Examples of the photoalignment functional group that undergoes isomerization when irradiated with light include azobenzene and tolane groups. Examples of the photoalignment functional group that undergoes photo-Fries rearrangement when irradiated with light include phenolic ester structures. Examples of the photoalignment functional group that undergoes decomposition when irradiated with light include cyclobutane structures.

In the present embodiment, the alignment film 40 disposed on the first substrate 10 including the interlayer insulating film 13 is only required to contain at least one selected from the group consisting of a group represented by the formula (S-1), a group represented by the formula (S-2), and a heteroaromatic group. The alignment film 50 disposed on the second substrate 20 may or may not contain at least one selected from the group consisting of a group represented by the formula (S-1), a group represented by the formula (S-2), and a heteroaromatic group. The alignment film 50 disposed on the second substrate 20 can be a common alignment film. In the case where the second substrate 20 includes an interlayer insulating film that contains at least one selected from a positive resist and a photoreaction product thereof, the alignment film 50 disposed on the second substrate 20 preferably contains at least one selected from the group consisting of a group represented by the formula (S-1), a group represented by the formula (S-2), and a heteroaromatic group, as with the alignment film 40 disposed on the first substrate 10.

The alignment film 40 contains one alignment film polymer or two or more different alignment film polymers. At least one of the alignment film polymers contains at least one selected from the group consisting of a group represented by the formula (S-1), a group represented by the formula (S-2), and a heteroaromatic group, i.e., a specific group. An alignment film 40 formed of an alignment film polymer containing a group represented by the formula (S-1) and/or a group represented by the formula (S-2), upon the photoalignment treatment, may contain a dimerized structure of the group represented by the formula (S-1) and/or a dimerized structure of the group represented by the formula (S-2). This alignment film 40 still contains the group represented by the formula (S-1) and/or the group represented by the formula (S-2) remaining therein. The alignment film 40 may contain only an alignment film polymer containing the specific group, or may contain an alignment film polymer containing no specific group as well as the alignment film polymer containing the specific group. The amount of the alignment film polymer containing the specific group in the whole alignment film polymers contained in the alignment film 40 is preferably 3 wt % or more and 50 wt % or less, more preferably 5 wt % or more and 20 wt % or less.

Only one of the repeating units in one molecule of the alignment film polymer may be a repeating unit containing at least one selected from the group consisting of a group represented by the formula (S-1), a group represented by the formula (S-2), and a heteroaromatic group. All the repeating units in one molecule may each be a repeating unit containing at least one selected from the group consisting of a group represented by the formula (S-1), a group represented by the formula (S-2), and a heteroaromatic group. Preferably, the repeating units containing at least one selected from the group consisting of a group represented by the formula (S-1), a group represented by the formula (S-2), and a heteroaromatic group constitute 40 mol % or more and 100 mol % or less of the repeating units in one molecule of the alignment film polymer containing the specific group in the present embodiment. Such a polymer can make the alignment film 40 anisotropic upon application of polarized ultraviolet light to provide a suitable alignment state to the liquid crystal material. If the repeating units containing at least one selected from the group consisting of a group represented by the formula (S-1), a group represented by the formula (S-2), and a heteroaromatic group constitute less than 40 mol % of the repeating units in one molecule of the alignment film polymer containing the specific group, the alignment of the liquid crystal compound in the liquid crystal material may be unstable. Meanwhile, even when the repeating units containing at least one selected from the group consisting of a group represented by the formula (S-1), a group represented by the formula (S-2), and a heteroaromatic group constitute 100 mol % of the repeating units in one molecule of the alignment film polymer containing the specific group, the liquid crystal compound can be sufficiently aligned.

The alignment film polymer containing the specific group preferably has a weight average molecular weight of 1,000 to 500,000, more preferably 10,000 to 100,000. If the alignment film polymer containing the specific group has a weight average molecular weight of less than 1,000, increasing the solution viscosity of a solution containing the alignment film polymer containing the specific group may be difficult. The alignment film 40 containing such an alignment film polymer may fail to have an appropriate film thickness when formed by ink jetting or printing. If the alignment film polymer containing the specific group has a weight average molecular weight of more than 500,000, the solution viscosity of a solution containing the alignment film polymer containing the specific group may be excessively high. The alignment film 40 containing such an alignment film polymer may be difficult to form by ink jetting or printing and have a wide film thickness distribution. The weight average molecular weight as used herein can be measured by gel permeation chromatography (GPC).

The alignment film 40 preferably contains at least one selected from a cinnamate group and a chalcone group. In other words, the alignment film polymer in the alignment film 40 preferably contains at least one selected from a cinnamate group and a chalcone group. The cinnamate group is a monovalent group obtained by removing the hydrogen atom from the carboxyl group in cinnamic acid, or a divalent group obtained by removing the hydrogen atom from the carboxyl group and one hydrogen atom from the benzene ring in cinnamic acid. The cinnamate group can contain at least one group selected from a group represented by the formula (S-1) and a group represented by the formula (S-2). The chalcone group is a monovalent group obtained by removing one hydrogen atom from one of the two benzene rings in chalcone, or a divalent group obtained by removing one hydrogen atom from each of the two benzene rings. The chalcone group can contain at least one group selected from a group represented by the formula (S-1) and a group represented by the formula (S-2).

The cinnamate group and the chalcone group are photoalignment functional groups which, when irradiated with light, are dimerized and isomerized, for example, as described above. The alignment film 40, when containing at least one selected from the cinnamate group and the chalcone group, can reduce the VHR decrease and the residual DC voltage increase due to long-term use, thereby reducing flicker due to the VHR decrease and image sticking due to the residual DC voltage. In addition, the alignment film 40 can be subjected to photoalignment treatment, and thus can avoid defects such as streaky display unevenness and static electricity that can be generated by use of a rubbing alignment film. Since contactless alignment treatment is possible, the alignment treatment can improve the alignment of the liquid crystal and the alignment stability without deteriorating elements such as the TFTs.

The group represented by the formula (S-1) and the group represented by the formula (S-2) are each preferably contained in a side chain of the alignment film polymer. If the group represented by the formula (S-1) and the group represented by the formula (S-2) are contained in the main chain of the alignment film polymer, the steric restriction in the polymer conformation may be strong, so that the group represented by the formula (S-1) and the group represented by the formula (S-2) may not easily undergo photoreactions (dimerization and isomerization).

The heteroaromatic group preferably contains a heterocycle containing a secondary amino group. This can cause the interaction shown by the following formula 4 (Van der Waals interaction (in particular, an interaction between the NH group in the heteroaromatic group and the ketone (—C═O) group in the NQD, and an interaction between the aromatic ring in the heteroaromatic group and the aromatic ring in the NQD)), further reducing dissolution of an unreacted moiety of the NQD into the liquid crystal layer 30 through the alignment film 40. The liquid crystal display device 1 therefore can reduce the VHR decrease and the residual DC voltage increase, reducing flicker due to the VHR decrease and image sticking due to the residual DC voltage.

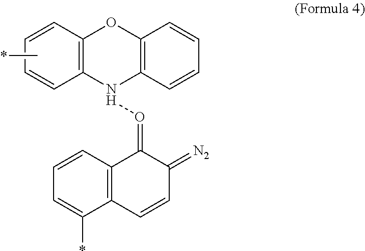

The heteroaromatic group is more preferably at least one selected from the group consisting of indole, benzimidazole, purine, phenoxazine, and phenothiazine groups. Such a heteroaromatic group is likely to form a hydrogen bond with an NQD even when the interlayer insulating film contains the NQD, further reducing dissolution of an unreacted moiety of the NQD into the liquid crystal layer 30 through the alignment film 40. Since the molecular weight distribution of a polymer is typically greater than 1, the alignment film 40 may contain an alignment film polymer having a relatively small molecular weight per molecule. A polymer having a relatively small molecular weight among the alignment film polymers containing the specific group seems to easily dissolve in the liquid crystal layer 30 and generate a radical when irradiated with light. With the heteroaromatic group being at least one selected from the group consisting of indole, benzimidazole, purine, phenoxazine, and phenothiazine groups, the interaction in the heteroaromatic group can be increased and the restriction in the conformation of the alignment film polymer containing the specific group can be increased, so that the polymer chain is imparted with rigidity. Such a heteroaromatic group can also increase the interaction between the alignment film polymers containing the specific group. Such a heteroaromatic group can therefore reduce dissolution of the alignment film polymers containing the specific group into the liquid crystal layer 30. This mechanism can reduce generation of radicals from the alignment film polymers containing the specific group in the liquid crystal layer 30. The alignment film polymer containing the specific group can contain a photoalignment functional group such as a cinnamate group or a chalcone group which is similar to the mesogens and are therefore likely to interact with the liquid crystal layer 30. Even in such a case, with the heteroaromatic group being at least one selected from the group consisting of indole, benzimidazole, purine, phenoxazine, and phenothiazine groups, generation of radicals in the liquid crystal layer 30 can be effectively reduced. The indole, benzimidazole, purine, phenoxazine, and phenothiazine groups are obtained by removing one or more hydrogen atoms from indole, benzimidazole, purine, phenoxazine, and phenothiazine, respectively.

Examples of the indole group include heteroaromatic groups represented by the following formula (D1). Examples of the benzimidazole group include heteroaromatic groups represented by the following formula (D2). Examples of the purine group include heteroaromatic groups represented by the following formula (D3). Examples of the phenoxazine group include heteroaromatic groups represented by the following formulas (D4) and (D6). Examples of the phenothiazine group include heteroaromatic groups represented by the following formulas (D5) and (D7). The groups represented by the following formulas (D1) to (D7) may or may not contain a substituent. Yet, the groups represented by the following formulas (D1) to (D7) preferably do not contain any substituent, for synthesis of the alignment film polymer.

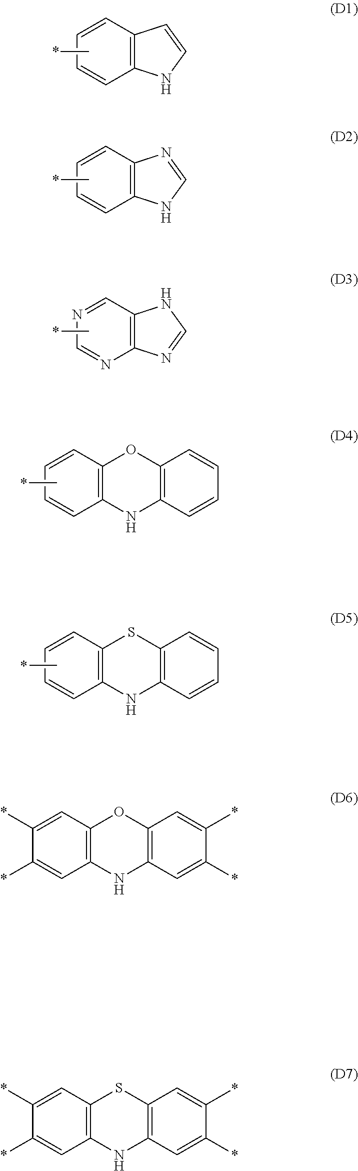

The heteroaromatic group is preferably contained in the main chain or side chain of the alignment film polymer. In the case where the heteroaromatic group is contained in a side chain of the alignment film polymer, the heteroaromatic group is preferably one represented by any one of the formulas (D1) to (D5). In the case where the heteroaromatic group is contained in the main chain of the alignment film polymer, the heteroaromatic group is preferably one represented by the formula (D6) or (D7).

In the case where the alignment film 40 contains at least one group selected from a group represented by the formula (S-1) and a group represented by the formula (S-2), the alignment film polymer in the alignment film 40 preferably contains at least one structure represented by the following formula (PA-1) or (PI-1). An alignment film polymer containing a structure represented by the following formula (PA-1) contains a polyamic acid structure in its main chain structure. An alignment film polymer containing a structure represented by the following formula (PI-1) contains a polyimide structure in its main chain structure.

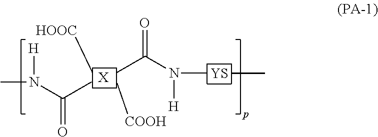

In the formula (PA-1), Xs are the same as or different from each other and each a tetravalent group; YSs are the same as or different from each other and each a divalent group containing a group represented by the formula (S-1) or a group represented by the formula (S-2); and p is an integer of 1 or greater.

In one molecule of a polyamic acid containing a structure represented by the formula (PA-1), Xs may include one group or two or more different groups, and YSs may include one group or two or more different groups.

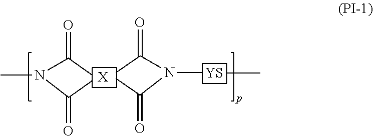

In the formula (PI-1), Xs are the same as or different from each other and each a tetravalent group; YSs are the same as or different from each other and each a divalent group containing a group represented by the formula (S-1) or a group represented by the formula (S-2); and p is an integer of 1 or greater.

In one molecule of a polyimide containing a structure represented by the formula (PI-1), Xs may include one group or two or more different groups, and YSs may include one group or two or more different groups.

In the case where the alignment film 40 contains the heteroaromatic group, the alignment film polymer in the alignment film 40 preferably contains at least one structure represented by any one of the following formulas (PA-2), (PA-3), (PI-2), and (PI-3). An alignment film polymer containing a structure represented by the following formula (PA-2) or (PA-3) contains a polyamic acid structure in its main chain structure. An alignment film polymer containing a structure represented by the following formula (PI-2) or (PI-3) contains a polyimide structure in its main chain structure.

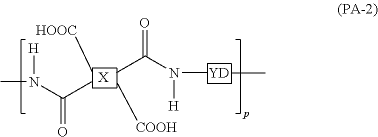

In the formula (PA-2), Xs are the same as or different from each other and each a tetravalent group; YDs are the same as or different from each other and each a divalent group containing a heteroaromatic group represented by any one of the formulas (D1) to (D5); and p is an integer of 1 or greater.

In one molecule of a polyamic acid containing a structure represented by the formula (PA-2), Xs may include one group or two or more different groups, and YDs may include one group or two or more different groups.

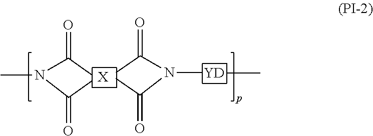

In the formula (PI-2), Xs are the same as or different from each other and each a tetravalent group; YDs are the same as or different from each other and each a divalent group containing a heteroaromatic group represented by any one of the formulas (D1) to (D5); and p is an integer of 1 or greater.

In one molecule of a polyimide containing a structure represented by the formula (PI-2), Xs may include one group or two or more different groups, and YDs may include one group or two or more different groups.

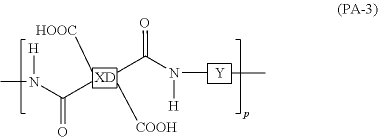

In the formula (PA-3), XDs are the same as or different from each other and each a tetravalent group containing a heteroaromatic group represented by the formula (D6) or (D7); Ys are the same as or different from each other and each a divalent group; and p is an integer of 1 or greater.

In one molecule of a polyamic acid containing a structure represented by the formula (PA-3), XDs may include one group or two or more different groups, and Ys may include one group or two or more different groups.

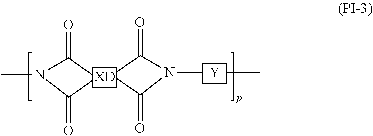

In the formula (PI-3), XDs are the same as or different from each other and each a tetravalent group containing a heteroaromatic group represented by the formula (D6) or (D7); Ys are the same as or different from each other and each a divalent group; and p is an integer of 1 or greater.

In one molecule of a polyimide containing a structure represented by the formula (PI-3), XDs may include one group or two or more different groups, and Ys may include one group or two or more different groups.

In the case where the alignment film 40 contains a group represented by the formula (S-1) and/or a group represented by the formula (S-2) as well as the heteroaromatic group, the alignment film polymer in the alignment film 40 more preferably contains at least one structure represented by any one of the following formulas (PA-4), (PA-5), (PI-4), and (PI-5). An alignment film polymer containing a structure represented by the following formula (PA-4) or (PA-5) contains a polyamic acid structure in its main chain structure. An alignment film polymer containing a structure represented by the following formula (PI-4) or (PI-5) contains a polyimide structure in its main chain structure.

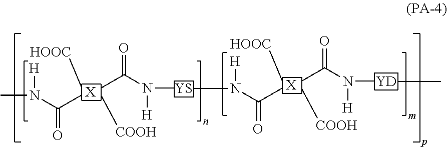

In the formula (PA-4), Xs are the same as or different from each other and each a tetravalent group; YSs are the same as or different from each other and each a divalent group containing a group represented by the formula (S-1) or a group represented by the formula (S-2); YDs are the same as or different from each other and each a divalent group containing a heteroaromatic group represented by any one of the formulas (D1) to (D5); m, n, and p are each independently an integer of 1 or greater; and m and n satisfy the relation 0<m/(m+n)<1.

In one molecule of a polyamic acid containing a structure represented by the formula (PA-4), Xs may include one group or two or more different groups, YSs may include one group or two or more different groups, and YDs may include one group or two or more different groups.

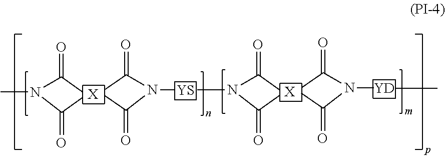

In the formula (PI-4), Xs are the same as or different from each other and each a tetravalent group; YSs are the same as or different from each other and each a divalent group containing a group represented by the formula (S-1) or a group represented by the formula (S-2); YDs are the same as or different from each other and each a divalent group containing a heteroaromatic group represented by any one of the formulas (D1) to (D5); m, n, and p are each independently an integer of 1 or greater; and m and n satisfy the relation 0<m/(m+n)<1.

In one molecule of a polyimide containing a structure represented by the formula (PI-4), Xs may include one group or two or more different groups, YSs may include one group or two or more different groups, and YDs may include one group or two or more different groups.

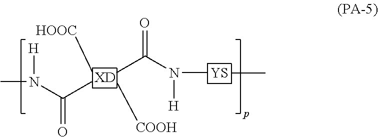

In the formula (PA-5), XDs are the same as or different from each other and each a tetravalent group containing a heteroaromatic group represented by the formula (D6) or (D7); YSs are the same as or different from each other and each a divalent group containing a group represented by the formula (S-1) or a group represented by the formula (S-2); and p is an integer of 1 or greater.

In one molecule of a polyamic acid containing a structure represented by the formula (PA-5), XDs may include one group or two or more different groups, and YSs may include one group or two or more different groups.

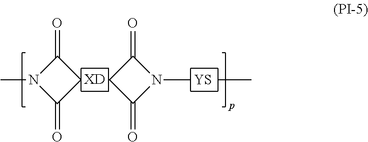

In the formula (PI-5), XDs are the same as or different from each other and each a tetravalent group containing a heteroaromatic group represented by the formula (D6) or (D7); YSs are the same as or different from each other and each a divalent group containing a group represented by the formula (S-1) or a group represented by the formula (S-2); and p is an integer of 1 or greater.

In one molecule of a polyimide containing a structure represented by the formula (PI-5), XDs may include one group or two or more different groups, and YSs may include one group or two or more different groups.

Xs in the formulas (PA-1), (PI-1), (PA-2), (PI-2), (PA-4), and (PI-4) are the same as or different from each other and each a tetravalent group, more preferably a C4-C20 tetravalent group containing at least one selected from an aromatic group and an alicyclic group, still more preferably a C6-C20 tetravalent group containing an aromatic group or a C4-C20 tetravalent group containing an alicyclic group, particularly preferably a C4-C10 tetravalent group containing a C4-C6 alicyclic group. In the case where X contains two or more cyclic structures, the cyclic structures may be bonded directly or via a linking group or may be condensed. Examples of the linking group include C1-C5 hydrocarbon, —O—, —N═N—, —C≡C—, —CH═CH—, and —CO—CH═CH— groups.

Specific examples of Xs include chemical structures represented by the following formulas (X-1) to (X-16). At least one hydrogen atom in each structure may be replaced by a halogen atom, a methyl group, or an ethyl group.

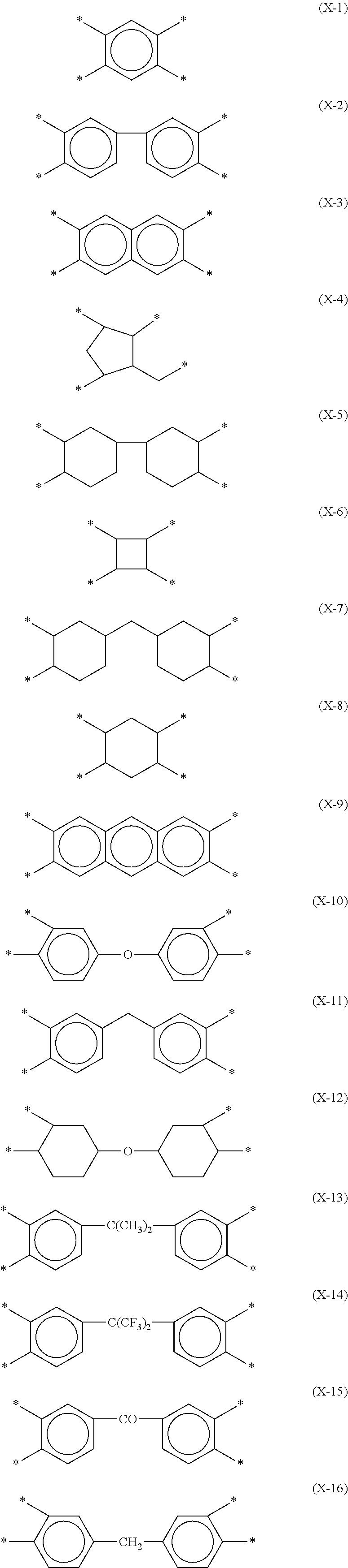

XDs in the formulas (PA-3), (PI-3), (PA-5), and (PI-5) are the same as or different from each other and each preferably a tetravalent group containing a heteroaromatic group represented by the formula (D6) or (D7), more preferably a heteroaromatic group represented by the formula (D6) or (D7).

Ys in the formulas (PA-3) and (PI-3) are the same as or different from each other and each a divalent group, more preferably a C4-C40 divalent group containing at least one selected from an aromatic group and an alicyclic group, still more preferably a C10-C40 divalent group containing an aromatic group and an alicyclic group, particularly preferably a divalent group containing a C6-C10 aromatic group and a C10-C30 alicyclic group. In the case where Y contains two or more cyclic structures, the cyclic structures may be bonded directly or via a linking group, or may be condensed. Examples of the linking group include C1-C5 hydrocarbon, —O—, —N═N—, —C≡C—, —CH═CH—, and —CO—CH═CH— groups.

Specific examples of Ys include chemical structures represented by the following formulas (Y-1) to (Y-25). At least one hydrogen atom in each structure may be replaced by a halogen atom, a methyl group, or an ethyl group.

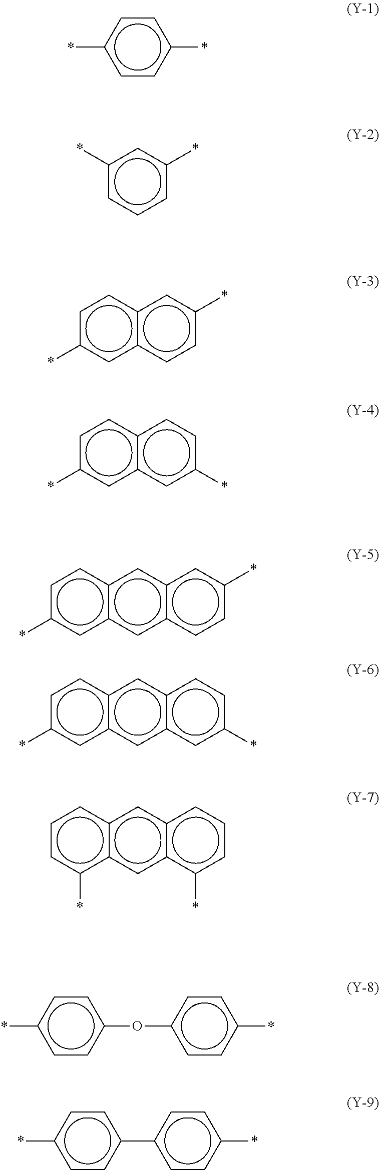

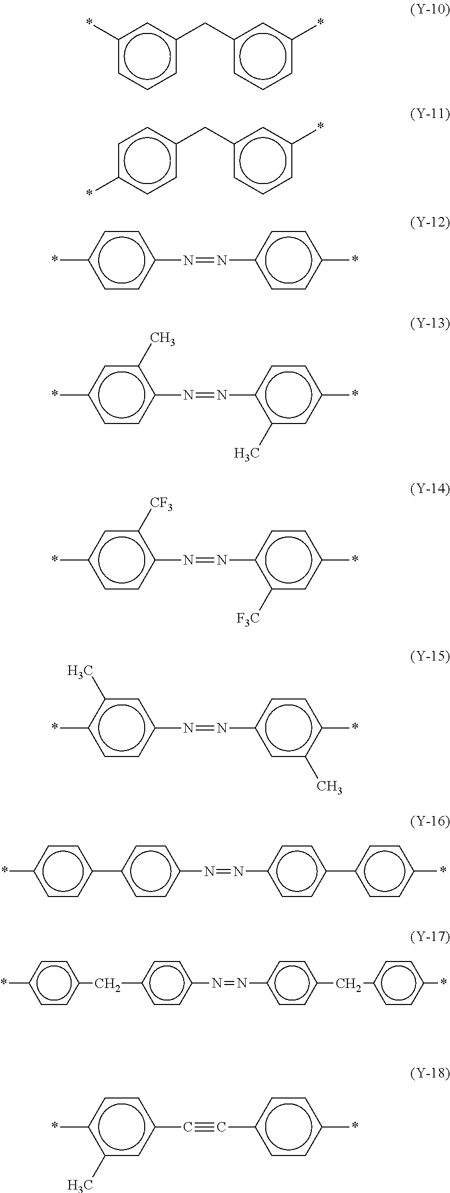

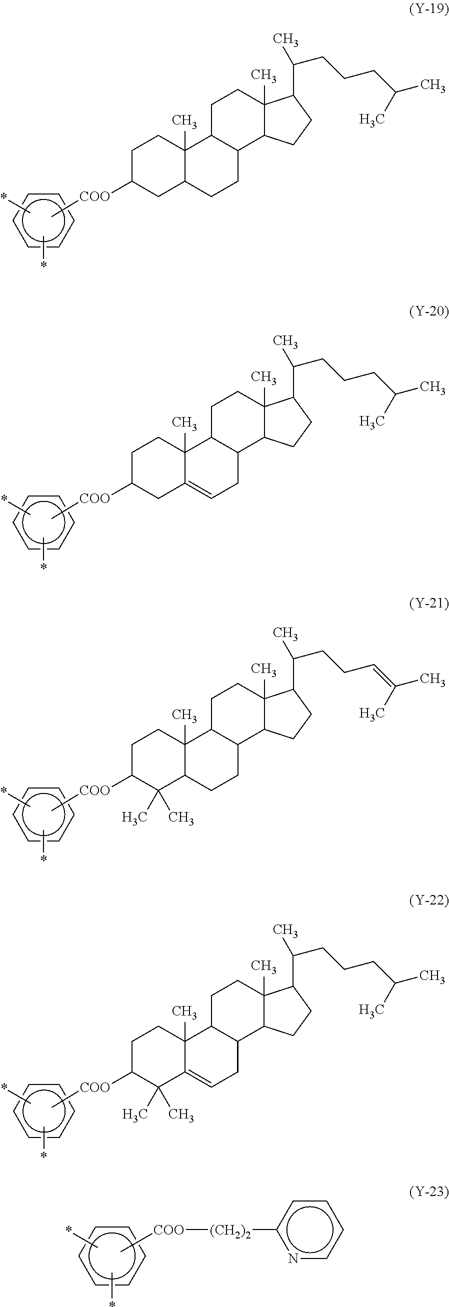

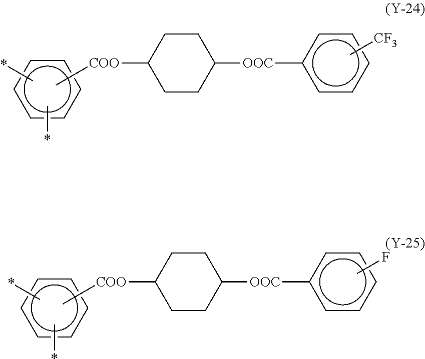

YSs in the formulas (PA-1), (PI-1), (PA-4), (PI-4), (PA-5), and (PI-5) are the same as or different from each other, and are each a divalent group containing a group represented by the formula (S-1) or a group represented by the formula (S-2), more preferably a C9-C30 divalent group containing a group represented by the formula (S-1) or a group represented by the formula (S-2).

Specific examples of YSs include chemical structures represented by the following formulas (YS-1) to (YS-18). At least one hydrogen atom in each structure may be replaced by a halogen atom, a methyl group, or an ethyl group.

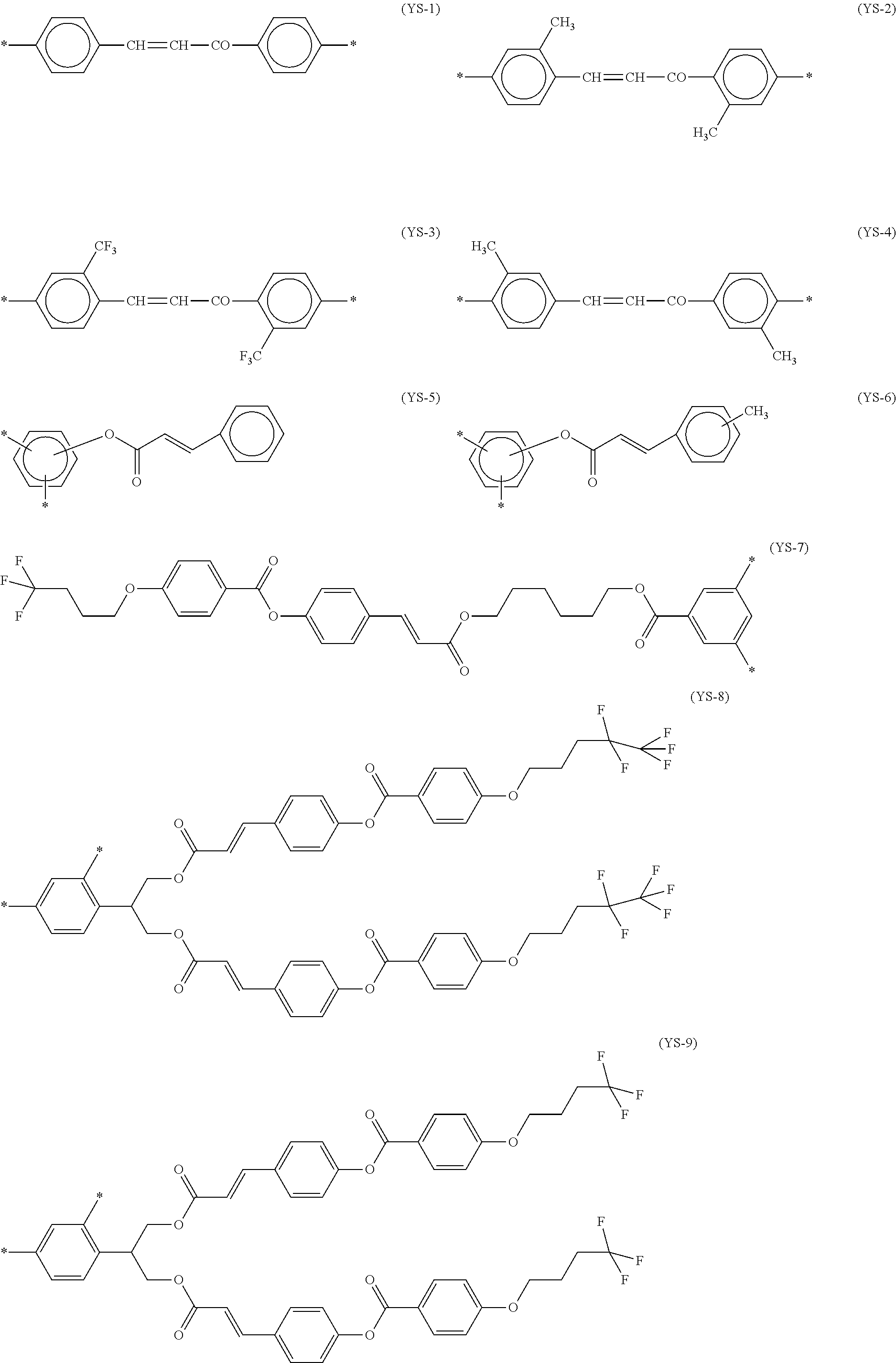

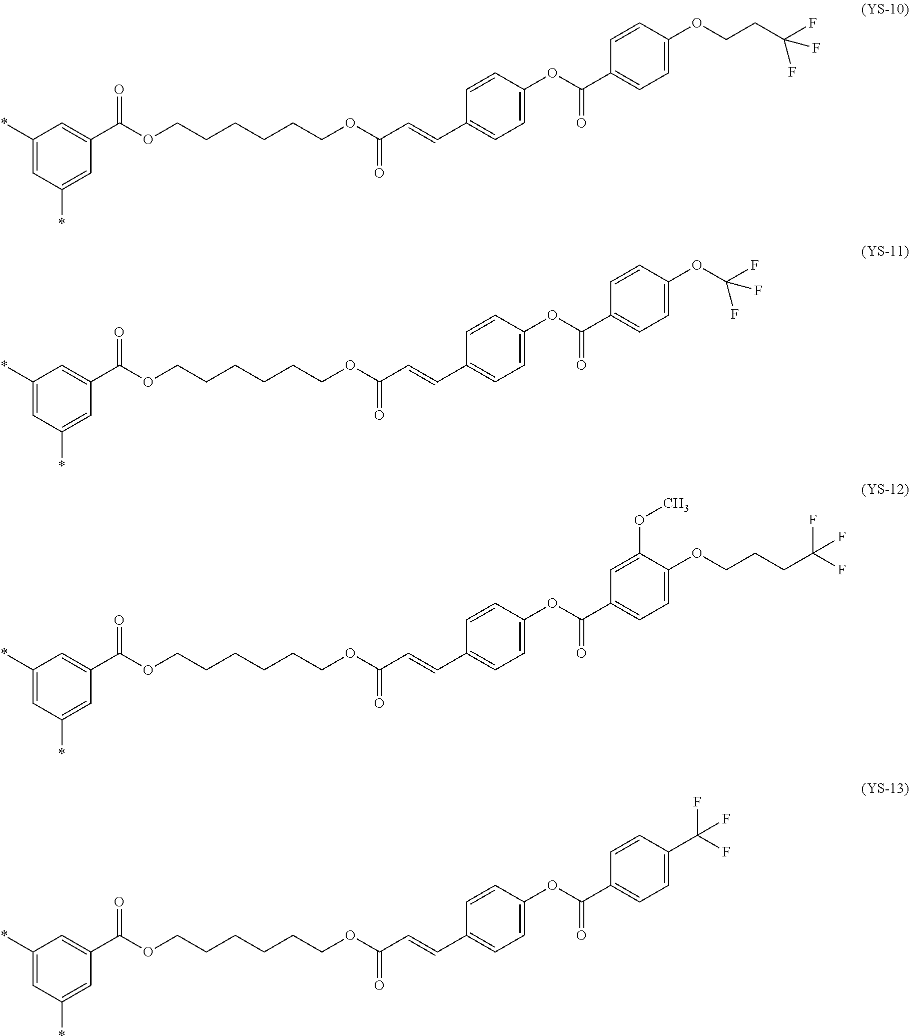 [SMILES: *c1cc(*)cc(C(=O)OCCCCCCOC(=O)/C=C/c2ccc(OC(=O)c3ccc(OCCC(F)(F)F)cc3)cc2)c1 ; *c1cc(*)cc(C(=O)OCCCCCCOC(=O)/C=C/c2ccc(OC(=O)c3ccc(OC(F)(F)F)cc3)cc2)c1 ; *c1cc(*)cc(C(=O)OCCCCCCOC(=O)/C=C/c2ccc(OC(=O)c3ccc(OCCCC(F)(F)F)c(OC)c3)cc2)c1 ; *c1cc(*)cc(C(=O)OCCCCCCOC(=O)/C=C/c2ccc(OC(=O)c3ccc(C(F)(F)F)cc3)cc2)c1]

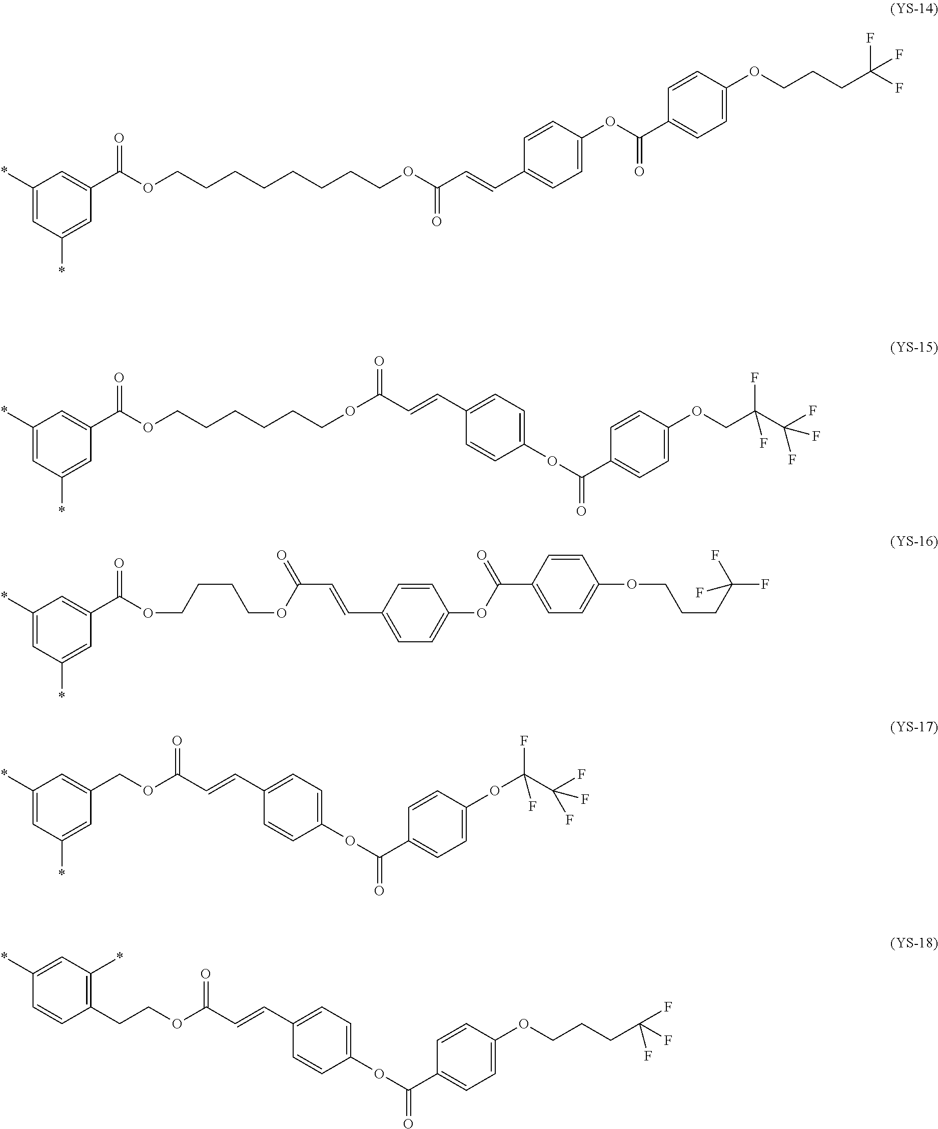

YDs in the formulas (PA-2), (PI-2), (PA-4), and (PI-4) are the same as or different from each other and each a divalent group containing a heteroaromatic group represented by any one of the formulas (D1) to (D5), more preferably a C5-C40 divalent group containing a heteroaromatic group represented by any one of the formulas (D1) to (D5).

Specific examples of YDs include chemical structures represented by the following formulas (YD-1) to (YD-10). At least one hydrogen atom in each structure may be replaced by a halogen atom, a methyl group, or an ethyl group.

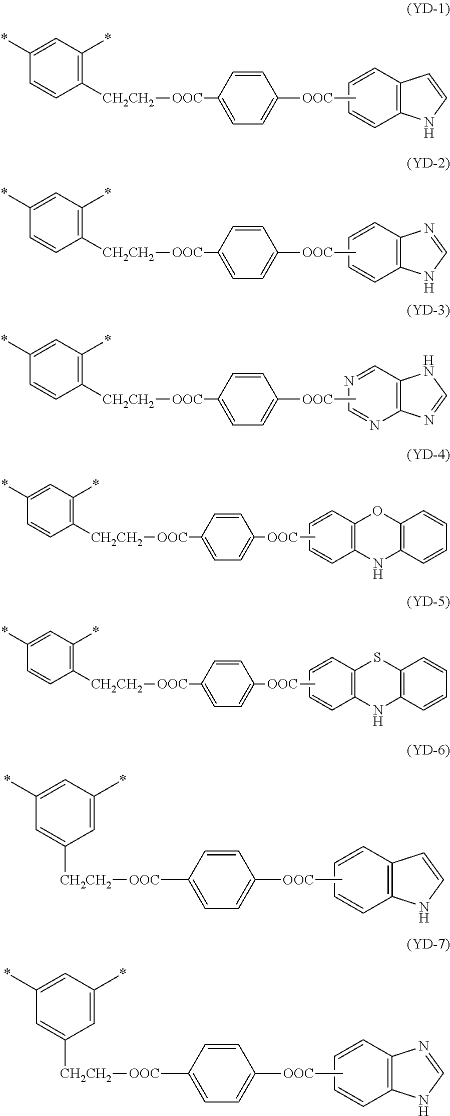

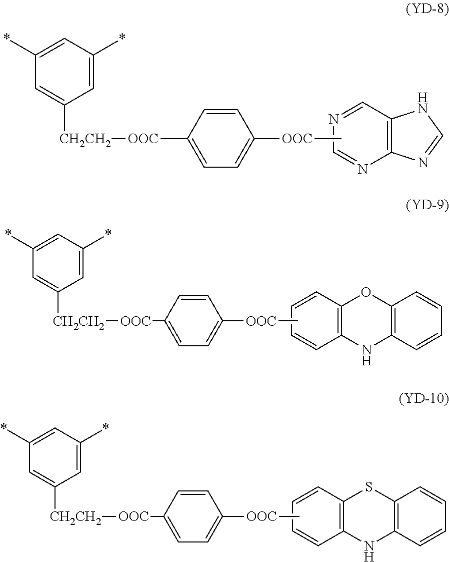

The ratio m/(m+n) in the formulas (PA-4) and (PI-4) are copolymerization ratios and each satisfy the relation 0<m/(m+n)<1, preferably the relation 0.05≤m/(m+n)≤0.6, more preferably the relation 0.1≤m/(m+n)≤0.3. If the ratio m/(m+n) in the formulas (PA-4) and (PI-4) is higher than 0.6, the liquid crystal alignment stability in the photoalignment treatment may be low. If the ratio m/(m+n) in the formulas (PA-4) and (PI-4) is lower than 0.05, the effect achieved by introducing the heteroaromatic group, i.e., the effect of reducing the amount of radical ions generated in the liquid crystal layer 30, may be difficult to achieve.

The case has been described in which the main chain structure of the alignment film polymer containing the specific group has a polyamic acid structure or a polyimide structure. Examples of the main chain structure of the alignment film polymer containing the specific group include a polysiloxane structure and a polyvinyl structure, as well as the polyamic acid structure and the polyimide structure. In other words, the alignment film 40 preferably contains at least one polymer main chain structure selected from the group consisting of a polyamic acid structure, a polyimide structure, a polysiloxane structure, and a polyvinyl structure. This is because the synthesis method of polymers containing as their main chain structure a polyamic acid structure, a polyimide structure, a polysiloxane structure, or a polyvinyl structure has already been established, the molecular weights of these polymers can be controlled to some extent, and the polymers have high stability against heat. In particular, polymers having a polyamic acid structure, a polyimide structure, or a polysiloxane structure as their main chain structure have higher heat stability. Polymers having a polyimide structure as their main chain structure have even higher heat stability.

In the case where the alignment film polymer containing the specific group contains at least one group selected from a group represented by the formula (S-1) and a group represented by the formula (S-2) and the heteroaromatic group and has a polysiloxane structure as its main chain structure, the alignment film polymer containing the specific group preferably contains a structure represented by the following formula (PS-1), more preferably a structure represented by the following formula (PS-2).

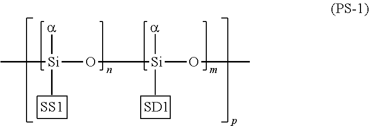

In the formula (PS-1), SS1s are the same as or different from each other, and each a monovalent group containing a group represented by the formula (S-1) or a group represented by the formula (S-2); SD1s are the same as or different from each other, and each a monovalent group containing a heteroaromatic group represented by any one of the formulas (D1) to (D5); αs are the same as or different from each other, and each a hydrogen atom, a hydroxy group, or a C1-C5 alkoxy group; m, n, and p are each independently an integer of 1 or greater; and m and n satisfy the relation 0<m/(m+n)<1.

In one molecule of a polysiloxane containing a structure represented by the formula (PS-1), SS1s may include one group or two or more different groups, SD1s may include one group or two or more different groups, and αs may include one atom or group or include two or more different atoms or groups.

SS1s in the formula (PS-1) are the same as or different from each other, and each a monovalent group containing a group represented by the formula (S-1) or a group represented by the formula (S-2), preferably a C9-C30 monovalent group containing a group represented by the formula (S-1) or a group represented by the formula (S-2).

SD1s in the formula (PS-1) are the same as or different from each other, and each a monovalent group containing a heteroaromatic group represented by any one of the formulas (D1) to (D5), preferably a C5-C40 monovalent group containing a heteroaromatic group represented by any one of the formulas (D1) to (D5).

The ratio m/(m+n) in the formula (PS-1) is a copolymerization ratio and satisfies the relation 0<m/(m+n)<1, preferably the relation 0.05≤m/(m+n)≤0.6, more preferably the relation 0.1≤m/(m+n)≤0.3. If the ratio m/(m+n) in the formula (PS-1) is higher than 0.6, the liquid crystal alignment stability in the photoalignment treatment may be low. If the ratio m/(m+n) in the formula (PS-1) is lower than 0.05, the effect achieved by introducing the heteroaromatic group, i.e., the effect of reducing the amount of radical ions generated in the liquid crystal layer 30, may be difficult to achieve.

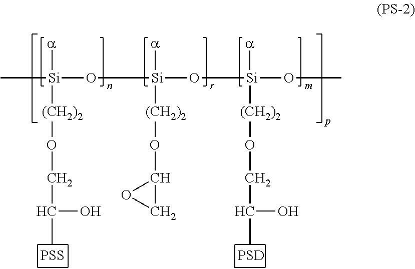

In the formula (PS-2), PSSs are the same as or different from each other, and each a monovalent group containing a group represented by the formula (S-1) or a group represented by the formula (S-2); PSDs are the same as or different from each other, and each a monovalent group containing a heteroaromatic group represented by any one of the formulas (D1) to (D5); as are the same as or different from each other, and each a hydrogen atom, a hydroxy group, or a C1-C5 alkoxy group; m, n, r, and p are each independently an integer of 1 or greater; and m, n, and r satisfy the relations 0<m/(m+n+r)≤0.5 and 0<r/(m+n+r)≤0.5.

In one molecule of a polysiloxane containing a structure represented by the formula (PS-2), PSSs may include one group or two or more different groups, PSDs may include one group or two or more different groups, and αs may include one atom or group or include two or more different atoms or groups.

PSSs in the formula (PS-2) are the same as or different from each other, and each a monovalent group containing a group represented by the formula (S-1) or a group represented by the formula (S-2), preferably a C9-C30 monovalent group containing a group represented by the formula (S-1) or a group represented by the formula (S-2).

PSDs in the formula (PS-2) are the same as or different from each other, and each a monovalent group containing a heteroaromatic group represented by any one of the formulas (D1) to (D5), preferably a C5-C40 monovalent group containing a heteroaromatic group represented by any one of the formulas (D1) to (D5).

Specific examples of PSSs in the formula (PS-2) include chemical structures represented by the following formulas (PSS-1) to (PSS-5).

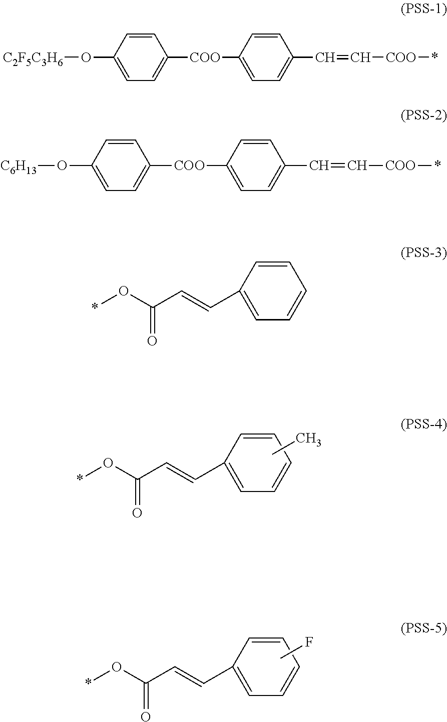

Specific examples of PSDs in the formula (PS-2) include chemical structures represented by the following formulas (PSD-1) to (PSD-5).

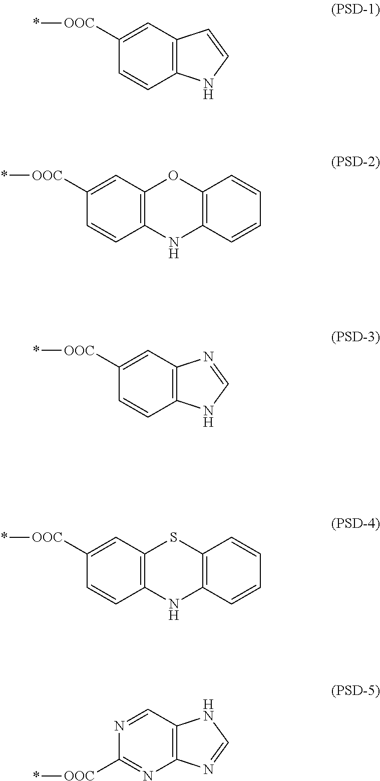

The ratios m/(m+n+r) and r/(m+n+r) in the formula (PS-2) are copolymerization ratios, and respectively satisfy the relations 0<m/(m+n+r)≤0.5 and 0<r/(m+n+r)≤0.5, preferably the relations 0.05≤m/(m+n+r)≤0.5 and 0≤r/(m+n+r)≤0.1, more preferably 0.1≤m/(m+n+r)≤0.3 and 0≤r/(m+n+r)≤0.05. The ratio of r (r/(m+n+r)) in the formula (PS-2) is preferably as low as possible, so that the ratio of the specific group can be increased. If the ratio m/(m+n+r) is lower than 0.05, the effect achieved by introducing the heteroaromatic group, i.e., the effect of reducing the amount of radical ions generated in the liquid crystal layer 30, may be difficult to achieve. If the ratio m/(m+n+r) is higher than 0.5, the liquid crystal alignment stability in the photoalignment treatment may be low.

In the case where the alignment film polymer containing the specific group contains at least one group selected from a group represented by the formula (S-1) and a group represented by the formula (S-2) and the heteroaromatic group and has a polyvinyl structure as its main chain structure, the alignment film polymer containing the specific group preferably contains a structure represented by the following formula (PV-1).

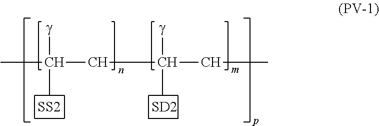

In the formula (PV-1), SS2s are the same as or different from each other, and each a monovalent group containing a group represented by the formula (S-1) or a group represented by the formula (S-2); SD2s are the same as or different from each other, and each a monovalent group containing a heteroaromatic group represented by any one of the formulas (D1) to (D5); γs are the same as or different from each other, and each a hydrogen atom or a C1-C5 alkyl group; m, n, and p are each independently an integer of 1 or greater; and m and n satisfy the relation 0<m/(m+n)<1.

In one molecule of a polyvinyl containing a structure represented by the formula (PV-1), SS2s may include one group or two or more different groups, SD2s may include one group or two or more different groups, and γs may include one atom or group or include two or more different atoms or groups.

SS2s in the formula (PV-1) are the same as or different from each other, and each a monovalent group containing a group represented by the formula (S-1) or a group represented by the formula (S-2), preferably a C9-C30 monovalent group containing at least one group represented by the formula (S-1) or the formula (S-2).

SD2s in the formula (PV-1) are the same as or different from each other, and each a monovalent group containing a heteroaromatic group represented by any one of the formulas (D1) to (D5), preferably a C5-C40 monovalent group containing a heteroaromatic group represented by any one of the formulas (D1) to (D5).

The ratio m/(m+n) in the formula (PV-1) is a copolymerization ratio and satisfies the relation 0<m/(m+n)<1, preferably the relation 0.05≤m/(m+n)≤0.6, more preferably the relation 0.1≤m/(m+n)≤0.3. If the ratio m/(m+n) in the formula (PV-1) is higher than 0.6, the liquid crystal alignment stability in the photoalignment treatment may be low. If the ratio m/(m+n) in the formula (PV-1) is lower than 0.05, the effect achieved by introducing the heteroaromatic group, i.e., the effect of reducing the amount of radical ions generated in the liquid crystal layer 30, may be difficult to achieve.

In the case where the alignment film polymer containing the specific group contains at least one selected from the group consisting of a polyamic acid structure, a polyimide structure, a polysiloxane structure, and a polyvinyl structure as its polymer main chain structure, the group represented by the formula (S-1) and the group represented by the formula (S-2) are preferably in a side chain of the alignment film polymer containing the specific group.

In the case where the alignment film polymer containing the specific group contains at least one selected from a polyamic acid structure and a polyimide structure as its polymer main chain structure, the heteroaromatic group is preferably in a side chain or the main chain of the alignment film polymer containing the specific group. In the case where the alignment film polymer containing the specific group contains at least one selected from a polysiloxane structure and a polyvinyl structure as its polymer main chain structure, the heteroaromatic group is preferably in a side chain of the alignment film polymer containing the specific group.

An alignment film polymer containing a structure represented by the formula (PA-1) or (PI-1) (alignment film polymer containing the specific group) can be obtained by, for example, reacting a mixture of a diamine containing a group represented by the formula (S-2) and a diamine containing the heteroaromatic group with an acid anhydride (preferably, carboxylic dianhydride).

An alignment film polymer containing a structure represented by the formula (PA-2) or (PI-2) (alignment film polymer containing the specific group) can be obtained by, for example, reacting a diamine containing a group represented by the formula (S-2) with an acid anhydride (preferably, carboxylic dianhydride) containing the heteroaromatic group.

The present invention is described in more detail below based on examples and comparative examples. The examples, however, are not intended to limit the scope of the present invention.

### Examples 1-1 to 1-5 and Comparative Examples 1-1 to 1-3

### (Preparation of Liquid Crystal Alignment Agent)

An alignment film polymer represented by the following formula (PA-1-1) (polyamic acid containing the group represented by the formula (S-2) and the heteroaromatic group) was synthesized. The alignment film polymer represented by the following formula (PA-1-1) had a weight average molecular weight of substantially 50,000.

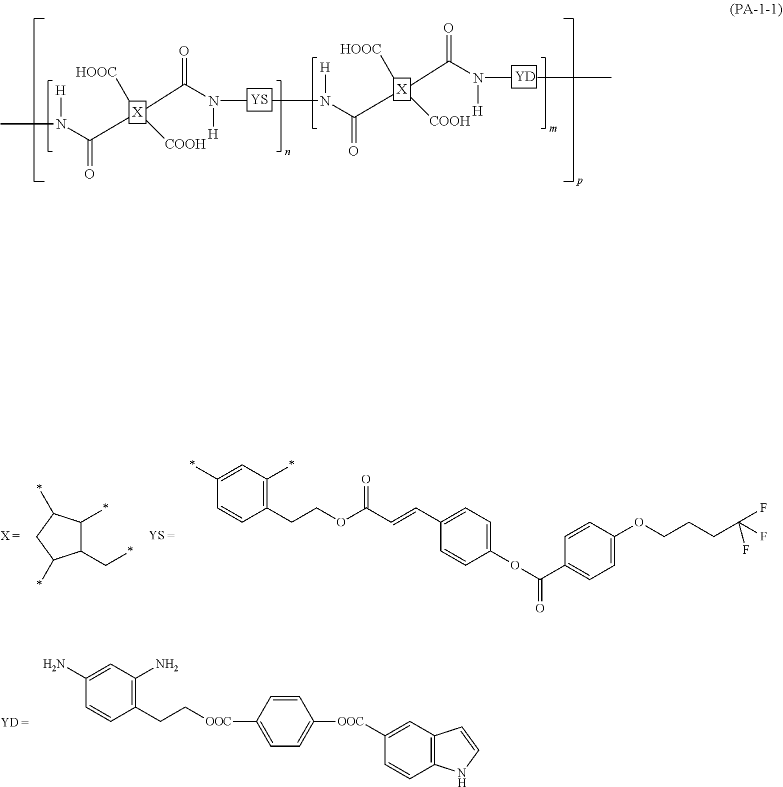

In particular, a diamine represented by the following formula (YM10), i.e., a diamine (0.07 mol) containing the group represented by the formula (S-2), and a diamine represented by the following formula (YM20), i.e., a diamine (0.03 mol) containing the heteroaromatic group, were dissolved in γ-butyrolactone to prepare a γ-butyrolactone solution. To the γ-butyrolactone solution was added a carboxylic dianhydride (0.10 mol) represented by the following formula (XM10), so that they were reacted at 60° C. for 12 hours for condensation polymerization. Thereby, an alignment film polymer (polyamic acid having a random structure) represented by the formula (PA-1-1) was obtained. In the diamine represented by the following formula (YM10), the group represented by the formula (S-2) is a group contained in the cinnamate group.

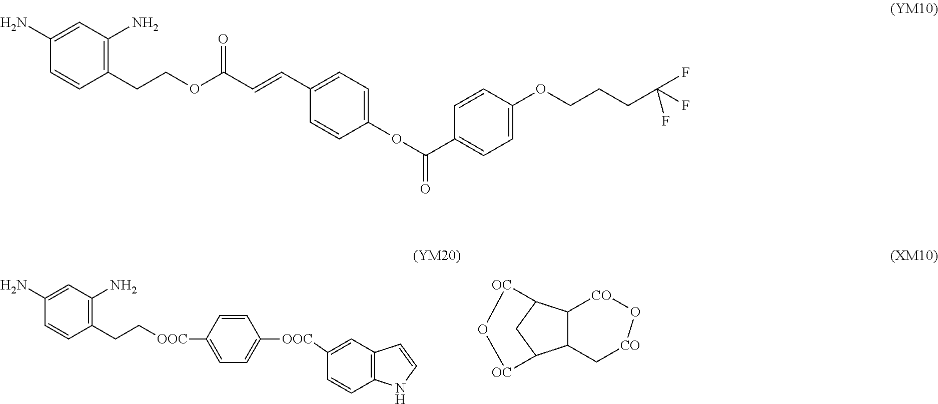

The alignment film polymer represented by the formula (PA-1-1) (m/(m+n)=0.25) was dissolved in a mixed solvent of NMP and γ-butyrolactone, so that a liquid crystal alignment agent 1-2A having a solids concentration of 5 wt % was prepared. Also, liquid crystal alignment agents 1-1A, 1-3A, 1-4A, and 1-5A were prepared as with the liquid crystal alignment agent 1-2A except that the ratio m/(m+n) in the formula (PA-1-1) was changed to 0, 0.50, 0.75, and 1.0, respectively.

An alignment film polymer (polyamic acid) represented by the following formula (PAR-1) was dissolved in a mixed solvent of NMP and γ-butyrolactone, so that a liquid crystal alignment agent 1R having a solids concentration of 5 wt % was prepared. The alignment film polymer represented by the following formula (PAR-1) had a weight average molecular weight of substantially 50,000.

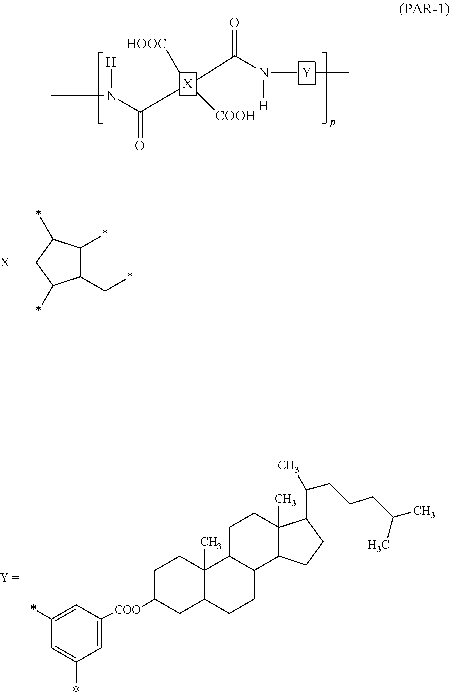

### (Production of Liquid Crystal Display Device)

A positive resist material was prepared which contained an insulating polymer (epoxy polymer), a novolac resin, and an NQD which is a positive resist photosensitizer. On an insulating substrate was formed a film of the positive resist material by spin coating. The solvent was removed by heating, and the film was irradiated with non-polarized ultraviolet light with a dose of 1 J/cm², so that an interlayer insulating film (positive resist) was formed. On the interlayer insulating film were stacked ITO pixel electrodes, whereby a first substrate was produced. The interlayer insulating film contained the insulating polymer (epoxy polymer), novolac resin, photoacid generator, and NQD which is a positive resist photosensitizer. Meanwhile, an ITO common electrode and a color filter layer were sequentially formed on an insulating substrate, whereby a second substrate was produced.

The liquid crystal alignment agent 1-1A was applied to the first substrate and the second substrate. The substrates were pre-baked at 90° C. for 5 minutes and post-baked at 200° C. for 40 minutes. Thereby, alignment films were formed. The alignment films formed on the first substrate and the second substrate were irradiated with linearly polarized ultraviolet light having a dominant wavelength of 330 nm with a dose of 20 mJ/cm², for alignment treatment.

To one of the substrates was applied an UV-curable sealant in a given pattern using a dispenser. Onto the given positions of the other substrate was dropped a negative liquid crystal material that contained a total of 5 wt % or more of at least one terphenyl compound represented by the following formula (A-EX1) and at least one tetraphenyl compound represented by the following formula (A-EX2), had a Tni of 90° C., and a Δn of 0.12. The substrates were bonded to each other in a vacuum, and the sealant was cured by ultraviolet light. The substrates were heated at 130° C. for 40 minutes for realignment treatment to transform the liquid crystal into an isotropic phase, followed by cooling to room temperature, whereby an UV2A-mode liquid crystal display device of Example 1-1 was obtained. UV2A-mode liquid crystal display devices of Examples 1-2, 1-3, 1-4, and 1-5 were obtained as with the liquid crystal display device of Example 1-1 except that the liquid crystal alignment agent 1-1A was changed to the liquid crystal alignment agents 1-2A, 1-3A, 1-4A, and 1-5A, respectively.

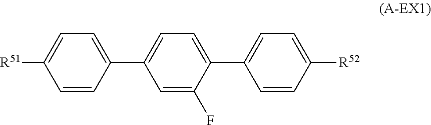

In the formula (A-EX1), R⁵¹ and R⁵² are each independently a C2, C3, or C4 alkyl group.

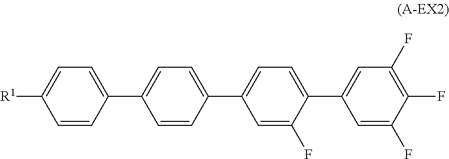

In the formula (A-EX2), R¹ is a C2, C3, or C4 alkyl group.

A VA-mode liquid crystal display device of Comparative Example 1-1 was obtained as with the liquid crystal display device of Example 1-1 except that the liquid crystal alignment agent 1-1A was changed to the liquid crystal alignment agent 1R and the alignment treatment was performed by rubbing instead of by applying linearly polarized ultraviolet light. A VA-mode liquid crystal display device of Comparative Example 1-2 was obtained as with the liquid crystal display device of Comparative Example 1-1 except that the liquid crystal material used was a negative liquid crystal material containing neither a terphenyl compound nor a tetraphenyl compound. A VA-mode liquid crystal display device of Comparative Example 1-3 was obtained as with the liquid crystal display device of Comparative Example 1-1 except that no interlayer insulating film was used.

In Examples 1-1 to 1-5 and Comparative Examples 1-1 to 1-3, the alignment films were formed by applying the liquid crystal alignment agents 1-1A to 1-5A and 1R, respectively, and then post-baking the substrates at 200° C. This caused the alignment film polymer (polyamic acid) represented by the formula (PA-1-1) to be partially converted into a polyimide, and caused the alignment film polymer (polyamic acid) represented by the formula (PAR-1) to be partially converted into a polyimide. In other words, the alignment films in the liquid crystal display devices of Examples 1-1 to 1-5 each contained a polyimide obtained by partially imidizing the alignment film polymer represented by the formula (PA-1-1), while the alignment films in the liquid crystal display devices of Comparative Examples 1-1 to 1-3 each contained a polyimide obtained by partially imidizing the alignment film polymer represented by the formula (PAR-1).

### (High-Temperature Test on Backlight)

In order to evaluate the reliability of the liquid crystal display devices of Examples 1-1 to 1-5 and Comparative Examples 1-1 to 1-3, each liquid crystal display device was subjected to a backlight exposure test at 80° C. for 1000 hours. The VHR was determined at 1 V and 70° C. using a VHR measurement system Model 6254 (Toyo Corp.). The residual DC voltage was determined by the flicker minimizing method. The rDC voltage was measured after application of a DC offset voltage of 2 V (AC voltage of 3 V (60 Hz)) for two hours. The contrast ratio was determined at 25° C. using the spectrophotometer UL-1 available from Topcon Technohouse Corporation. The results are shown in the following Table 1.

TABLE 1

| | | 0 Hours | | | After 1000 hours | | |
|---|---|---|---|---|---|---|---|
| | Polymer in | VHR | rDC | Contrast | VHR | rDC | Contrast |
| | alignment film | (%) | (mV) | ratio | (%) | (mV) | ratio |
| Example 1-1 | (PA-1-1) | 99.4 | 0 | 4200 | 98.3 | 30 | 4150 |
| | m/(m + n) = 0 | | | | | | |
| Example 1-2 | (PA-1-1) | 99.4 | 0 | 4200 | 99.0 | 20 | 4200 |
| | m/(m + n) = 0.25 | | | | | | |
| Example 1-3 | (PA-1-1) | 99.4 | −10 | 4000 | 99.0 | 10 | 4200 |
| | m/(m + n) = 0.50 | | | | | | |
| Example 1-4 | (PA-1-1) | 99.5 | −10 | 3600 | 99.1 | 10 | 3500 |
| | m/(m + n) = 0.75 | | | | | | |
| Example 1-5 | (PA-1-1) | 99.5 | −10 | N/A | 99.1 | 10 | N/A |
| | m/(m + n) = 1 | | | (pre-tilt | | | (pre-tilt |
| | | | | angle remained | | | angle remained |
| | | | | at 90° after | | | at 90° after |
| | | | | photoalignment | | | photoalignment |
| | | | | treatment) | | | treatment) |
| Comparative | (PAR-1) | 99.5 | −10 | 3700 | 96.5 | 110 | 3200 |
| Example 1-1 | | | | | | | |
| Comparative | (PAR-1) | 99.5 | −20 | 3600 | 98.8 | 0 | 3600 |
| Example 1-2 | | | | | | | |
| Comparative | (PAR-1) | 99.5 | −10 | 4000 | 99.2 | −10 | 3900 |
| Example 1-3 | | | | | | | |

Example 1-1 in which the alignment film polymer represented by the formula (PA-1-1) (m/(m+n)=0) was used for the alignment films was compared with Comparative Example 1-1 in which the alignment film polymer represented by the formula (PAR-1) was used. The comparison shows that the liquid crystal display device of Example 1-1 more reduced the VHR decrease and rDC voltage increase after 1000 hours of the backlight exposure test at a high temperature (high-temperature test on backlight) and thus achieved a higher VHR and a lower rDC voltage, so that the effect of enhancing long-term reliability was achieved.

The alignment films formed of the alignment film polymer represented by the formula (PAR-1) caused a VHR decrease and a rDC voltage increase after 1000 hours of the high-temperature test on the backlight. This is presumably because the NQD and a biradical thereof in the interlayer insulating film dissolved in the liquid crystal layer to cause an electron transfer reaction with at least one compound selected from a terphenyl compound and a tetraphenyl compound in the liquid crystal layer, forming a radical ion.

In contrast, the alignment films formed of the alignment film polymer represented by the formula (PA-1-1) successfully reduced formation of a radical ion in the liquid crystal layer. This is presumably because a cinnamate group containing the group represented by the formula (S-2) was introduced, so that the biradical formed a charge-transfer complex with the cinnamate group.

The liquid crystal display devices of Examples 1-2 to 1-4 in which a heteroaromatic group was introduced in the alignment film polymer represented by the formula (PA-1-1) more reduced the VHR decrease and the rDC voltage increase after 1000 hours of the high-temperature test on the backlight and thus achieved a higher VHR and a lower rDC voltage than Example 1-1. This is presumably because the interaction between the NQD (not a biradical) and the heteroaromatic group reduced the dissolution amount of the NQD dissolved in the liquid crystal layer.

The heteroaromatic group alone was introduced in the alignment film polymer represented by the formula (PA-1-1) and the photoalignment treatment was performed in Example 1-5. These processes left the pre-tilt angle of the liquid crystal compound remaining at 90°, and voltage application led to no response by the liquid crystal compound. Hence, no contrast ratio was achieved. Yet, the VHR decrease and the rDC voltage increase after 1000 hours of the high-temperature test on the backlight were further reduced.

These results show that the amounts of the NQD and a biradical thereof dissolved in the liquid crystal layer can be reduced and the VHR decrease and the rDC voltage increase after 1000 hours of the high-temperature test on the backlight can be reduced by introducing an alignment film polymer containing a group represented by the formula (S-2) or a heteroaromatic group into the alignment film. The results also show that the amounts of the NQD and a biradical thereof dissolved in the liquid crystal layer can be further reduced and the VHR decrease and the rDC voltage increase after 1000 hours of the high-temperature test on the backlight can be further reduced by introducing an alignment film polymer containing both a group represented by the formula (S-2) and a heteroaromatic group into the alignment films.

The results of Comparative Example 1-2 show that use of a liquid crystal material containing neither a terphenyl compound nor a tetraphenyl compound hardly led to a VHR decrease, a rDC voltage increase, and a contrast ratio decrease. The results of Comparative Example 1-3 show that with use of no interlayer insulating film, no radical ion was generated in the liquid crystal layer due to the components (e.g., NQD) in the interlayer insulating film, and a VHR decrease and a rDC voltage increase hardly occurred even when the liquid crystal display device was used for a long period of time.

### Examples 2-1 and 2-2

### (Preparation of Liquid Crystal Alignment Agent)

An alignment film polymer represented by the following formula (PA-5-1) and an alignment film polymer represented by the following formula (PA-3-1) were synthesized. The alignment film polymer represented by the following formula (PA-5-1) and the alignment film polymer represented by the following formula (PA-3-1) both had a weight average molecular weight of substantially 50,000. The alignment film polymer represented by the following formula (PA-5-1) is a polyamic acid containing the group represented by the formula (S-2) and the heteroaromatic group. The alignment film polymer represented by the following formula (PA-3-1) is a polyamic acid containing the heteroaromatic group.

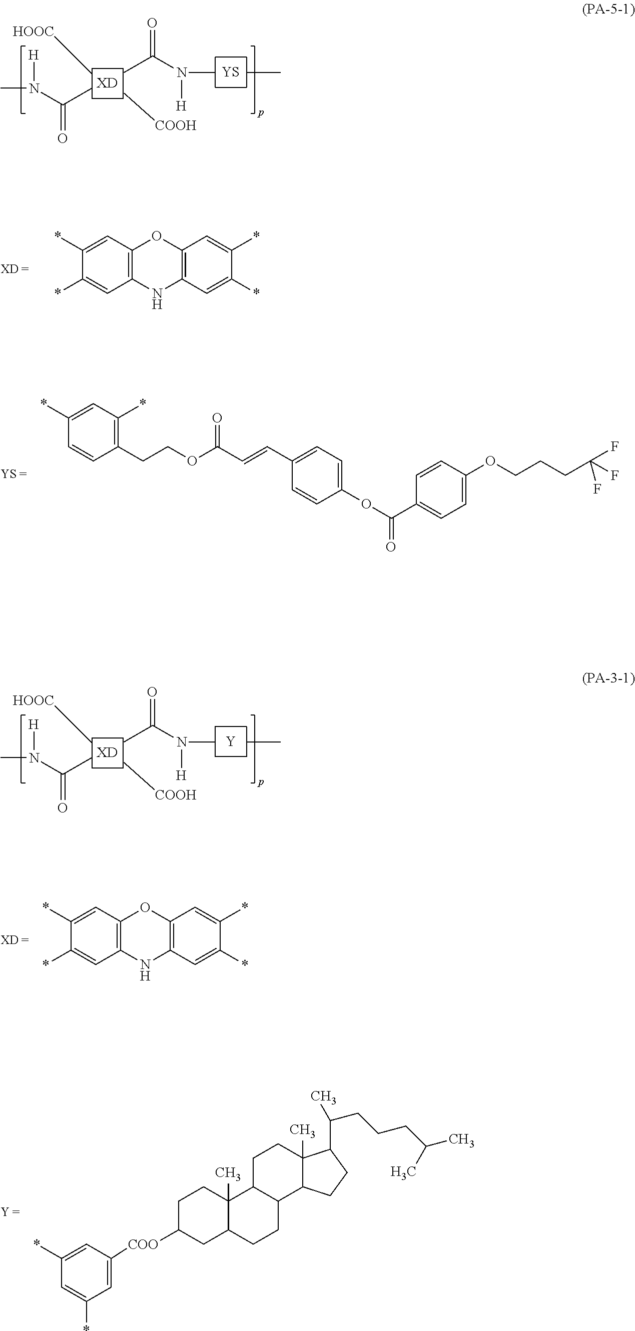

A specific method for synthesizing the alignment film polymer represented by the formula (PA-5-1) is described below. A diamine represented by the following formula (YM10), i.e., a diamine (0.10 mol) containing the group represented by the formula (S-2), was dissolved in γ-butyrolactone to prepare a γ-butyrolactone solution. To the γ-butyrolactone solution was added a carboxylic dianhydride (0.10 mol) represented by the following formula (XM20), i.e., a carboxylic dianhydride (0.10 mol) containing the heteroaromatic group, so that they were reacted at 60° C. for 12 hours for condensation polymerization. Thereby, an alignment film polymer represented by the formula (PA-5-1) was obtained. Δn alignment film polymer containing a structure represented by the formula (PA-3-1) was synthesized in the same manner but with a different structure of the corresponding diamine. In the diamine represented by the following formula (YM10), the group represented by the formula (S-2) is a group contained in the cinnamate group.

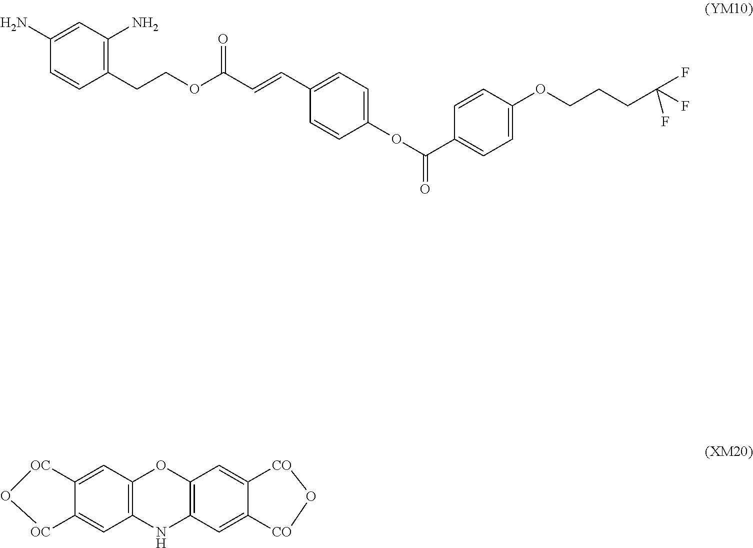

A liquid crystal alignment agent 2-1A was prepared as with the liquid crystal alignment agent 1-1A except that the alignment film polymer represented by the formula (PA-1-1) was changed to the alignment film polymer represented by the formula (PA-5-1). Likewise, a liquid crystal alignment agent 2-2A was prepared as with the liquid crystal alignment agent 1-1A except that the alignment film polymer represented by the formula (PA-1-1) was changed to the alignment film polymer represented by the formula (PA-3-1).

### (Production of Liquid Crystal Display Device)

A positive resist material was prepared which contained an insulating polymer (epoxy polymer), a novolac resin, and an NQD which is a positive resist photosensitizer. On the insulating substrate was formed a film of the positive resist material by spin coating. The solvent was removed by heating, and the film was irradiated with non-polarized ultraviolet light with a dose of 1 J/cm², so that an interlayer insulating film (positive resist) was formed. On the interlayer insulating film were stacked ITO pixel electrodes, whereby a first substrate was produced. The interlayer insulating film contained the insulating polymer (epoxy polymer), novolac resin, photoacid generator, and NQD which is a positive resist photosensitizer. Meanwhile, an ITO common electrode and a color filter layer were sequentially formed on an insulating substrate, and thereby a second substrate was produced.

The liquid crystal alignment agent 2-1A was applied to the first substrate and the second substrate. The substrates were pre-baked at 90° C. for 5 minutes and post-baked at 200° C. for 40 minutes. Thereby, alignment films were formed. The alignment films formed on the first substrate and the second substrate were irradiated with linearly polarized ultraviolet light having a dominant wavelength of 330 nm with a dose of 25 mJ/cm², for alignment treatment.

To one of the substrates was applied an UV-curable sealant in a given pattern using a dispenser. Onto the given positions of the other substrate was dropped a negative liquid crystal material that contained a total of 5 wt % or more of at least one terphenyl compound represented by the formula (A-EX1) and at least one tetraphenyl compound represented by the formula (A-EX2), had a Tni of 100° C., and a Δn of 0.12. The substrates were bonded to each other in a vacuum, and the sealant was cured by ultraviolet light. The substrates were heated at 130° C. for 40 minutes for realignment treatment to transform the liquid crystal into an isotropic phase, followed by cooling to room temperature, whereby an UV2A-mode liquid crystal display device of Example 2-1 was obtained. A VA-mode liquid crystal display device of Example 2-2 was obtained as with the liquid crystal display device of Example 2-1 except that the liquid crystal alignment agent 2-1A was changed to the liquid crystal alignment agent 2-2A and the alignment treatment was performed by rubbing instead of by applying polarized ultraviolet light.

In Examples 2-1 and 2-2, the alignment films were formed by applying the liquid crystal alignment agents 2-1A and 2-2A, respectively, and then post-baking the substrates at 200° C. This caused the alignment film polymer (polyamic acid) represented by the formula (PA-5-1) to be partially converted into a polyimide, and caused the alignment film polymer (polyamic acid) represented by the formula (PA-3-1) to be partially converted into a polyimide. In other words, the alignment films in the liquid crystal display device of Example 2-1 contained a polyimide obtained by partially imidizing the alignment film polymer represented by the formula (PA-5-1), while the alignment films in the liquid crystal display device of Example 2-2 contained a polyimide obtained by partially imidizing the alignment film polymer represented by the formula (PA-3-1).

### (High-Temperature Test on Backlight)

The liquid crystal display devices of Examples 2-1 and 2-2 were subjected to the high-temperature test on the backlight as in Example 1-1. The results are shown in the following Table 2.

TABLE 2

| | Polymer in | 0 Hours | | | After 1000 hours | | |
|---|---|---|---|---|---|---|---|
| | alignment | VHR | rDC | Contrast | VHR | rDC | Contrast |
| | film | (%) | (mV) | ratio | (%) | (mV) | ratio |
| Example | (PA-5-1) | 99.4 | 20 | 4300 | 99.2 | 20 | 4300 |
| 2-1 | | | | | | | |
| Example | (PA-3-1) | 99.4 | 20 | 3600 | 98.4 | 30 | 3500 |
| 2-2 | | | | | | | |

The heteroaromatic group was introduced into a side chain of the alignment film polymer (polyamic acid) in Examples 1-2 to 1-5, while the heteroaromatic group was introduced into the main chain of the alignment film polymer in Examples 2-1 and 2-2. A cinnamate group containing the group represented by the formula (S-2) was introduced into a side chain of the alignment film polymer in Example 2-1.

Example 2-1 in which the alignment film polymer containing the group represented by the formula (S-2) and the heteroaromatic group was used was compared with Example 2-2 in which the alignment film polymer containing the heteroaromatic group and no group represented by the formula (S-2) was used. The comparison shows that the liquid crystal display device of Example 2-1 had a greater effect of reducing the VHR decrease and rDC voltage increase after 1000 hours of the high-temperature test on the backlight and thus achieved a higher contrast ratio. The liquid crystal display device of Example 2-2 showed better results in the high-temperature test on the backlight than the liquid crystal display device of Comparative Example 1-1. The results confirmed that introduction of the heteroaromatic group into the polymer reduced the VHR decrease and rDC voltage increase after 1000 hours of the high-temperature test on the backlight and thus achieved a high VHR and a low rDC voltage, so that the effect of enhancing long-term reliability was achieved. The results also confirmed that the introduction reduced a contrast ratio decrease.

### Example 3

### (Preparation of Liquid Crystal Alignment Agent)

An alignment film polymer represented by the following formula (PS-2-1) (polysiloxane containing the group represented by the formula (S-2) and the heteroaromatic group) was synthesized. The alignment film polymer represented by the following formula (PS-2-1) had a weight average molecular weight of substantially 50,000.

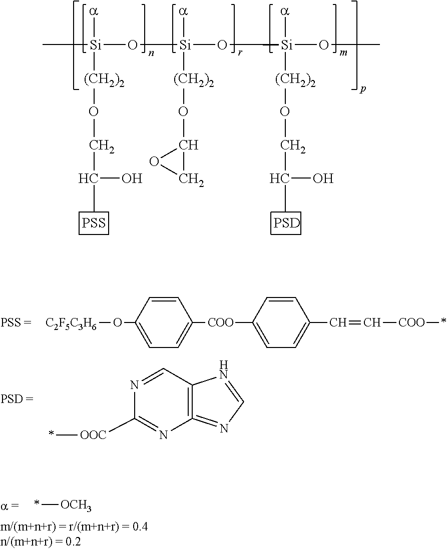

An alignment film polymer containing a structure represented by the formula (PS-2-1) was dissolved in a mixed solvent of NMP and γ-butyrolactone, so that a liquid crystal alignment agent 3A having a solids concentration of 5 wt % was prepared.

### (Production of Liquid Crystal Display Device)

A positive resist material was prepared which contained an insulating polymer (epoxy polymer), a novolac resin, and an NQD which is a positive resist photosensitizer. On the insulating substrate was formed a film of the positive resist material by spin coating. The solvent was removed by heating, and the film was irradiated with non-polarized ultraviolet light with a dose of 1 J/cm², so that an interlayer insulating film (positive resist) was formed. On the interlayer insulating film were stacked ITO pixel electrodes, whereby a first substrate was produced. The interlayer insulating film contained the insulating polymer (epoxy polymer), novolac resin, photoacid generator, and NQD which is a positive resist photosensitizer. Meanwhile, an ITO common electrode and a color filter layer were sequentially formed on an insulating substrate, and thereby a second substrate was produced.

The liquid crystal alignment agent 3A was applied to the first substrate and the second substrate. The substrates were pre-baked at 90° C. for 5 minutes and post-baked at 230° C. for 40 minutes. Thereby, alignment films were formed. The alignment films formed on the first substrate and the second substrate were irradiated with linearly polarized ultraviolet light having a dominant wavelength of 330 nm with a dose of 22 mJ/cm², for alignment treatment.

To one of the substrates was applied an UV-curable sealant in a given pattern using a dispenser. Onto the given positions of the other substrate was dropped a negative liquid crystal material that contained a total of 5 wt % or more of at least one terphenyl compound represented by the formula (A-EX1) and at least one tetraphenyl compound represented by the formula (A-EX2), had a Tni of 110° C., and a Δn of 0.12. The substrates were bonded to each other in a vacuum, and the sealant was cured by ultraviolet light. The substrates were heated at 130° C. for 40 minutes for realignment treatment to transform the liquid crystal into an isotropic phase, followed by cooling to room temperature, whereby an UV2A-mode liquid crystal display device of Example 3 was obtained.

### (High-Temperature Test on Backlight)

The liquid crystal display device of Example 3 was subjected to the high-temperature test on the backlight as in Example 1-1. The results are shown in the following Table 3.

TABLE 3

| | Polymer in | 0 Hours | | | After 1000 hours | | |
|---|---|---|---|---|---|---|---|
| | alignment | VHR | rDC | Contrast | VHR | rDC | Contrast |
| | film | (%) | (mV) | ratio | (%) | (mV) | ratio |
| Example 3 | (PS-2-1) | 99.4 | −30 | 4500 | 99.0 | −20 | 4500 |

The liquid crystal display device of Example 3 in which the alignment film polymer containing the polysiloxane structure as its main chain structure was used achieved the same effects as in Examples 1-1 to 1-5 and 2-1 to 2-2 in which the alignment film polymer containing at least one selected from the polyamic acid structure and the polyimide structure as its main chain structure was used.

### Examples 4-1 and 4-2 and Comparative Example 4

### (Preparation of Liquid Crystal Alignment Agent)

An alignment film polymer represented by the following formula (PS-2-2) (polysiloxane containing the group represented by the formula (S-1) and the heteroaromatic group), an alignment film polymer represented by the following formula (PS-2-3) (polysiloxane containing the group represented by the formula (S-1) and the heteroaromatic group), and an alignment film polymer represented by the following formula (PAR-2) (polyamic acid) were synthesized. The alignment film polymer represented by the following formula (PS-2-2), the alignment film polymer represented by the following formula (PS-2-3), and the alignment film polymer represented by the following formula (PAR-2) each had a weight average molecular weight of substantially 50,000.

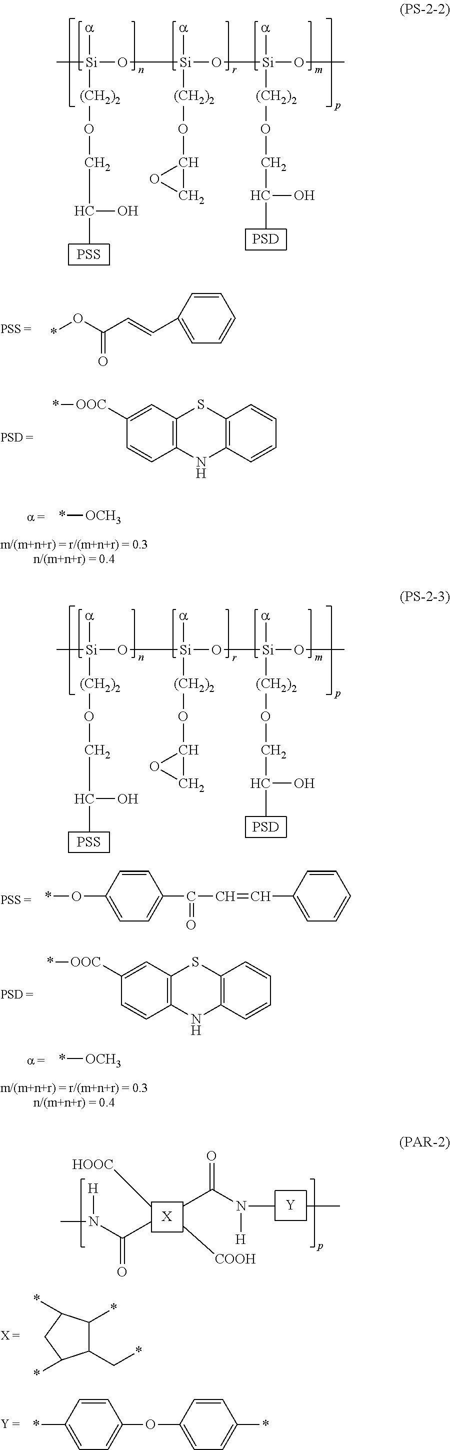

A polysiloxane represented by the formula (PS-2-2) was dissolved in a mixed solvent of NMP and γ-butyrolactone, so that a liquid crystal alignment agent 4-1A having a solids concentration of 5 wt % was prepared. Likewise, a polysiloxane represented by the formula (PS-2-3) was dissolved in a mixed solvent of NMP and γ-butyrolactone, so that a liquid crystal alignment agent 4-2A having a solids concentration of 5 wt % was prepared. A polyamic acid represented by the formula (PAR-2) was dissolved in a mixed solvent of NMP and γ-butyrolactone, so that a liquid crystal alignment agent 4R having a solids concentration of 5 wt % was prepared.

### (Production of Liquid Crystal Display Device)

A positive resist material was prepared which contained an insulating polymer (epoxy polymer), a novolac resin, and an NQD which is a positive resist photosensitizer. A film of the positive resist material was formed by spin coating. The solvent was removed by heating, and the film was irradiated with non-polarized ultraviolet light with a dose of 1 J/cm², so that an interlayer insulating film (positive resist) was formed. On the interlayer insulating film were sequentially stacked FFS-mode ITO pixel electrodes, a dielectric film formed of SiN (also referred to as a second insulating film), and an ITO common electrode, whereby a first substrate was produced. The interlayer insulating film contained the insulating polymer (epoxy polymer), novolac resin, photoacid generator, and NQD. Meanwhile, a color filter layer and an overcoat layer formed of an acrylic resin were formed on an insulating substrate, and thereby a second substrate was produced.

The liquid crystal alignment agent 4-1A was applied to the first substrate and the second substrate. The substrates were pre-baked at 90° C. for 5 minutes and post-baked at 230° C. for 40 minutes. Thereby, alignment films were formed. The alignment films formed on the first substrate and the second substrate were irradiated with linearly polarized ultraviolet light having a dominant wavelength of 330 nm with a dose of 50 mJ/cm², for alignment treatment.

To one of the substrates was applied an UV-curable sealant in a given pattern using a dispenser. Onto the given positions of the other substrate was dropped a positive liquid crystal material that contained a total of 5 wt % or more of at least one terphenyl compound represented by the formula (A-EX1) and at least one tetraphenyl compound represented by the formula (A-EX2), had a Tni of 97° C., and a Δn of 0.15. The substrates were bonded to each other in a vacuum, and the sealant was cured by ultraviolet light. The substrates were heated at 130° C. for 40 minutes for realignment treatment to transform the liquid crystal into an isotropic phase, followed by cooling to room temperature, whereby an FFS-mode liquid crystal display device of Example 4-1 was obtained. An FFS-mode liquid crystal display device of Example 4-2 was obtained as in Example 4-1 except that the liquid crystal alignment agent 4-1A was changed to the liquid crystal alignment agent 4-2A. An FFS-mode liquid crystal display device of Comparative Example 4 was obtained as in Example 4-1 except that the liquid crystal alignment agent 4-1A was changed to the liquid crystal alignment agent 4R, and the alignment films were formed by applying the liquid crystal alignment agent 4R to the first substrate and the second substrate, pre-baking the substrates at 90° C. for 5 minutes, post-baking the substrates at 200° C. for 40 minutes, and performing the alignment treatment by rubbing.

### (High-Temperature Test on Backlight)

The liquid crystal display devices of Examples 4-1 and 4-2 and Comparative Example 4 were subjected to the high-temperature test on the backlight as in Example 1-1. The results are shown in the following Table 4.

TABLE 4

| | Polymer in | 0 Hours | | | After 1000 hours | | |
|---|---|---|---|---|---|---|---|
| | alignment | VHR | rDC | Contrast | VHR | rDC | Contrast |
| | film | (%) | (mV) | ratio | (%) | (mV) | ratio |
| Example | (PS-2-2) | 99.2 | −10 | 800 | 99.0 | −10 | 800 |
| 4-1 | | | | | | | |
| Example | (PS-2-3) | 99.4 | −20 | 820 | 98.7 | 0 | 800 |
| 4-2 | | | | | | | |
| Compar- | (PAR-2) | 99.4 | −10 | 870 | 97.8 | 20 | 780 |
| ative | | | | | | | |
| Example 4 | | | | | | | |

The results confirmed that introduction of the group represented by the formula (S-1) and the heteroaromatic group into the alignment film polymer in the FFS-mode (horizontal alignment mode) liquid crystal display devices also reduced the VHR decrease and the rDC voltage increase after 1000 hours of the high-temperature test on the backlight and thus achieved a high VHR and a low rDC voltage, so that the effect of enhancing long-term reliability was achieved. The results also confirmed that the introduction also reduced a contrast ratio decrease.

In contrast, the alignment films formed of an alignment film polymer represented by the formula (PAR-2) caused a VHR decrease and a rDC voltage increase after 1000 hours of the high-temperature test on the backlight. This is presumably because the NQD and a biradical thereof in the interlayer insulating film dissolved in the liquid crystal layer to cause an electron transfer reaction with at least one compound selected from a terphenyl compound and a tetraphenyl compound in the liquid crystal layer, forming a radical ion.

A focus is now placed on the liquid crystal material. With a negative liquid crystal material, the VHR decreased by 3.0% and the rDC voltage increased by 120 mV after 1000 hours in Comparative Example 1-1, while the VHR decrease was as low as 0.4% or 1.1% and the rDC voltage increase was as low as 20 mV or 30 mV after 1000 hours in Examples 1-1 to 1-5. With a positive liquid crystal material, the VHR decreased by 1.6% and the rDC voltage increased by 30 mV after 1000 hours in Comparative Example 4, while the VHR decrease was as low as 0.2% and 0.7% and the rDC voltage increase was as low as 0 mV and 20 mV, respectively, after 1000 hours in Examples 4-1 and 4-2. These results show that the alignment film polymer containing the specific group can be more effectively utilized in a negative liquid crystal material.

### ADDITIONAL REMARKS

One aspect of the present invention may be the liquid crystal display device 1 including: the first substrate 10; the second substrate 20 facing the first substrate 10; the liquid crystal layer 30 held between the first substrate 10 and the second substrate 20; and the alignment film 40 disposed on a surface adjacent to the liquid crystal layer 30 of one or both of the first substrate 10 and the second substrate 20, the one or both of the first substrate 10 and the second substrate 20 with the alignment film 40 disposed thereon including the interlayer insulating film 13 that contains at least one selected from a positive resist and a photoreaction product thereof, the liquid crystal layer 30 containing a liquid crystal material that contains at least one selected from a terphenyl compound and a tetraphenyl compound, the alignment film 40 containing at least one selected from the group consisting of a group represented by the following formula (S-1), a group represented by the following formula (S-2), and a heteroaromatic group:

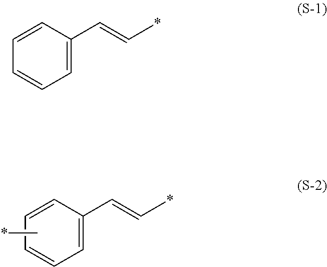

wherein at least one hydrogen atom in the aromatic ring may be replaced by a methyl group, an ethyl group, or a halogen atom, and at least one hydrogen atom in the vinyl group may be replaced by a methyl group or a halogen atom.

A group represented by the formula (S-1) and/or a group represented by the formula (S-2) are/is introduced into the alignment film 40 disposed on the first substrate 10 including the interlayer insulating film 13. This causes an electron transfer reaction between a biradical derived from the positive resist (e.g., NQD) in the interlayer insulating film 13 and the group represented by the formula (S-1) and/or the group represented by the formula (S-2) to generate radical ions inside the alignment film 40. The reaction reduces occurrence of an electron transfer reaction between the terphenyl compound and/or the tetraphenyl compound in the liquid crystal layer 30 and the biradical. Radical ions generated inside the alignment film 40 are not, or substantially not, diffused or spread to the liquid crystal layer 30. This mechanism can reduce the amount of radical ions to be generated in the liquid crystal layer 30, thereby reducing the VHR decrease and the DC voltage increase with time due to the mobility (e.g., diffusibility) of the radical ions in the liquid crystal layer 30 even when the liquid crystal display device 1 is used for a long period of time. The liquid crystal display device 1 therefore can reduce the VHR decrease and the residual DC voltage increase due to long-term use of the device, reducing flicker due to the VHR decrease and image sticking due to the residual DC voltage.

A heteroaromatic group is introduced into the alignment film 40 disposed on the first substrate 10 including the interlayer insulating film 13. This causes the Van der Waals interaction between the positive resist (e.g., NQD) in the interlayer insulating film 13 and the heteroaromatic group, reducing dissolution of an unreacted moiety of the positive resist into the liquid crystal layer 30 through the alignment film 40. This mechanism can reduce the amount of radicals to be generated in the liquid crystal layer 30 even when the liquid crystal display device 1 is used for a long period of time. The liquid crystal display device 1 therefore can reduce the VHR decrease and the residual DC voltage increase due to long-term use of the device, reducing flicker due to the VHR decrease and image sticking due to the residual DC voltage.

The positive resist may contain a naphthoquinone diazide compound (NQD). An NQD can reduce defects due to contact failure between the TFTs and the corresponding pixel electrodes 14 in the process of patterning the interlayer insulating film 13 and bringing the TFTs and the corresponding pixel electrodes 14 into contact with each other.

The liquid crystal material may have a nematic-isotropic transition temperature of 90° C. or higher and 115° C. or lower. If having a Tni of lower than 90° C., the liquid crystal material tends to transform into an isotropic phase, and the phase transition may cause display defects in liquid crystal display devices for in-vehicle or digital signage applications which are used at high temperatures. In contrast, if having a Tni of higher than 115° C., the liquid crystal material may exhibit low response performance.

The liquid crystal material may contain at least one selected from compounds represented by the following formulas (A-1a) to (A-1c) and (A-2a) to (A-2g). Such a liquid crystal material can have high Δn and a low rotational viscosity.

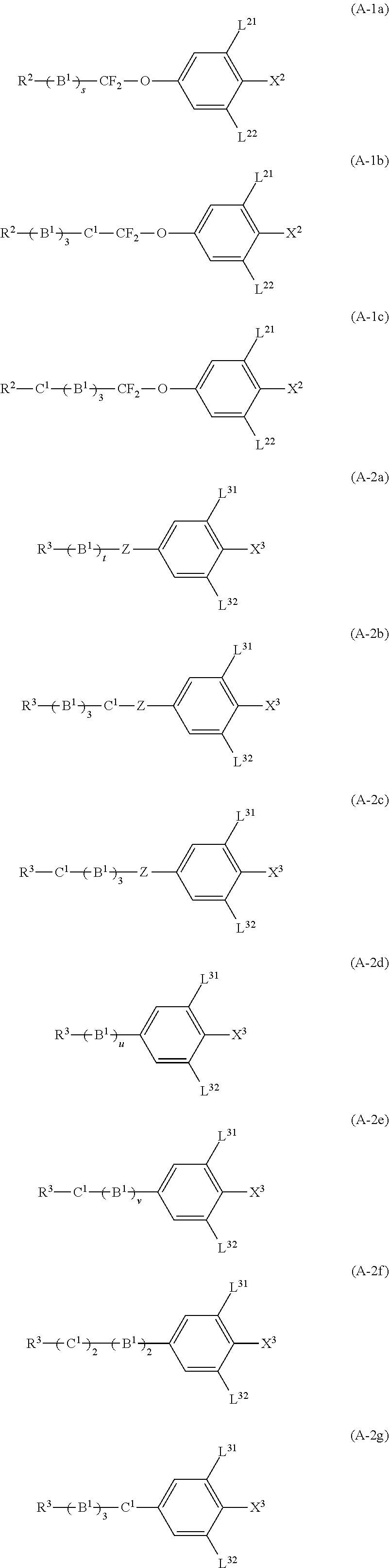

In the formulas (A-1a) to (A-1c) and (A-2a) to (A-2g), R² and R³ are each independently a C1-C7 alkyl, alkoxy, fluorinated alkyl, or fluorinated alkoxy group, or a C2-C7 alkenyl, alkenyloxy, alkoxyalkyl, or fluorinated alkenyl group; B¹ is any one of groups represented by the following formulas (b11) to (b15); C¹ is any one of groups represented by the following formulas (c11) to (c24); L²¹, L²², L, and L³² are each independently a hydrogen atom or a fluorine atom; X² and X³ are each independently a halogen atom, a C1-C3 halogenated alkyl or alkoxy group, or a C2-C3 halogenated alkenyl or alkenyloxy group; Z is —CH₂CH₂—, —CF₂CF₂—, —COO—, trans-CH═CH—, trans-CF═CF—, or —CH₂O—; s and t are each independently 3 or 4; and u and v are each independently 2 or 3,

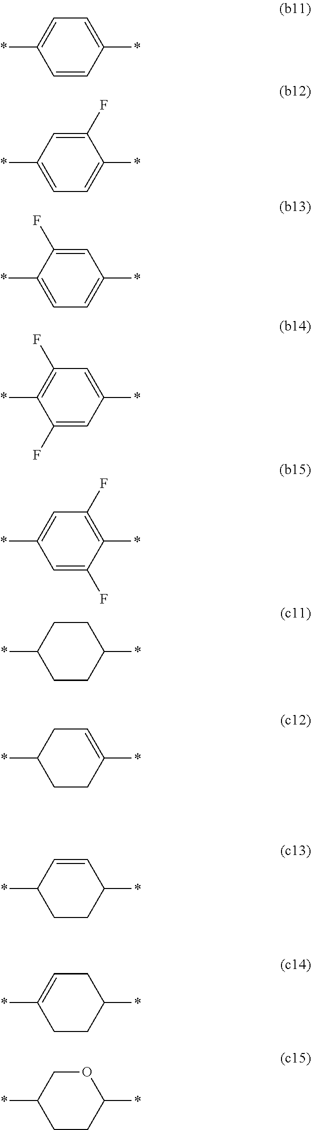

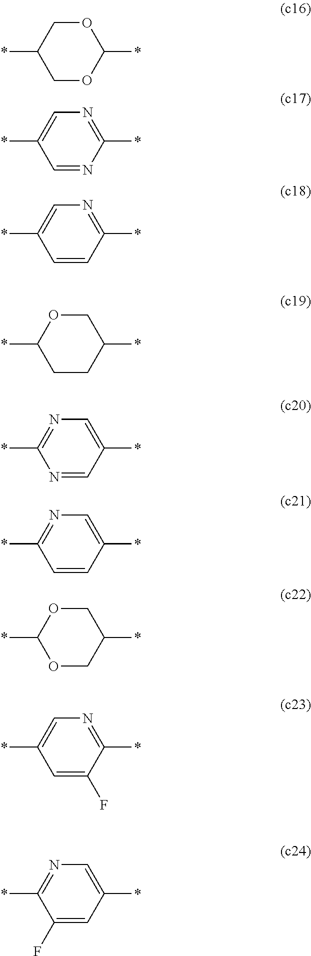

wherein * is a binding site.

The alignment film 40 may contain at least one selected from a cinnamate group and a chalcone group. Such an alignment film 40 can reduce the VHR decrease and the residual DC voltage increase due to long-term use, thereby reducing flicker due to the VHR decrease and image sticking due to the residual DC voltage. In addition, the alignment film 40 can be subjected to photoalignment treatment, and thus can avoid defects such as streaky display unevenness and static electricity that can be generated by use of a rubbing alignment film.

The heteroaromatic group may contain a heterocycle containing a secondary amino group. Such a heteroaromatic group can further enhance the interaction between the positive resist (e.g., NQD) and the alignment film polymer, further reducing dissolution of an unreacted moiety of the NQD into the liquid crystal layer 30 through the alignment film 40. The liquid crystal display device 1 therefore can reduce the VHR decrease and the residual DC voltage increase due to long-term use of the device, reducing flicker due to the VHR decrease and image sticking due to the residual DC voltage.

The heteroaromatic group may be at least one selected from the group consisting of an indole group, a benzimidazole group, a purine group, a phenoxazine group, and a phenothiazine group. Such a heteroaromatic group is likely to form a hydrogen bond with an NQD even when the interlayer insulating film contains the NQD, further reducing dissolution of an unreacted moiety of the NQD into the liquid crystal layer 30 through the alignment film 40. Since the molecular weight distribution of a polymer is typically greater than 1, the alignment film 40 may contain an alignment film polymer having a relatively small molecular weight per molecule. A polymer having a relatively small molecular weight among the alignment film polymers containing the specific group seems to easily dissolve in the liquid crystal layer 30 and generate a radical when irradiated with light. With the heteroaromatic group being at least one selected from the group consisting of indole, benzimidazole, purine, phenoxazine, and phenothiazine groups, the interaction in the heteroaromatic group can be increased and the restriction in the conformation of the alignment film polymer containing the specific group can be increased, so that the polymer chain is imparted with rigidity. Such a heteroaromatic group can also increase the interaction between the alignment film polymers containing the specific group. Such a heteroaromatic group can therefore reduce dissolution of the alignment film polymers containing the specific group into the liquid crystal layer 30. This mechanism can reduce generation of radicals from the alignment film polymers containing the specific group in the liquid crystal layer 30. The alignment film polymer containing the specific group can contain a photoalignment functional group such as a cinnamate group or a chalcone group which is similar to the mesogens and are therefore likely to interact with the liquid crystal layer 30. Even in such a case, with the heteroaromatic group being at least one selected from the group consisting of indole, benzimidazole, purine, phenoxazine, and phenothiazine groups, generation of radicals in the liquid crystal layer 30 can be effectively reduced.

The alignment film 40 may contain at least one polymer main chain structure selected from the group consisting of a polyamic acid structure, a polyimide structure, a polysiloxane structure, and a polyvinyl structure. The polymers containing as their main chain structure a polyamic acid structure, a polyimide structure, a polysiloxane structure, or a polyvinyl structure are preferred because the synthesis method of these polymers has already been established, the molecular weights of these polymers can be controlled to some extent, and the polymers have high stability against heat.

What is claimed is:

1. A liquid crystal display device comprising:
a first substrate;
a second substrate facing the first substrate;
a liquid crystal layer held between the first substrate and the second substrate; and
an alignment film disposed on a surface adjacent to the liquid crystal layer of one or both of the first substrate and the second substrate,
the one or both of the first substrate and the second substrate with the alignment film disposed thereon including an interlayer insulating film that contains at least one selected from a positive resist and a photoreaction product thereof,
the liquid crystal layer containing a liquid crystal material that contains at least one selected from a terphenyl compound and a tetraphenyl compound,
the alignment film containing at least one selected from the group consisting of a group represented by the following formula (S-1), a group represented by the following formula (S-2), and a heteroaromatic group: 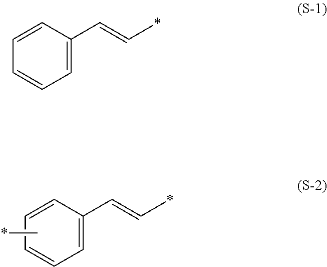
wherein at least one hydrogen atom in the aromatic ring may be replaced by a methyl group, an ethyl group, or a halogen atom, and at least one hydrogen atom in the vinyl group may be replaced by a methyl group or a halogen atom.

2. The liquid crystal display device according to claim 1,
wherein the positive resist contains a naphthoquinone diazide compound.

3. The liquid crystal display device according to claim 1,
wherein the liquid crystal material has a nematic-isotropic transition temperature of 90° C. or higher and 115° C. or lower.

4. The liquid crystal display device according to claim 1,
wherein the liquid crystal material contains at least one selected from compounds represented by the following formulas (A-1a) to (A-1c) and (A-2a) to (A-2g): 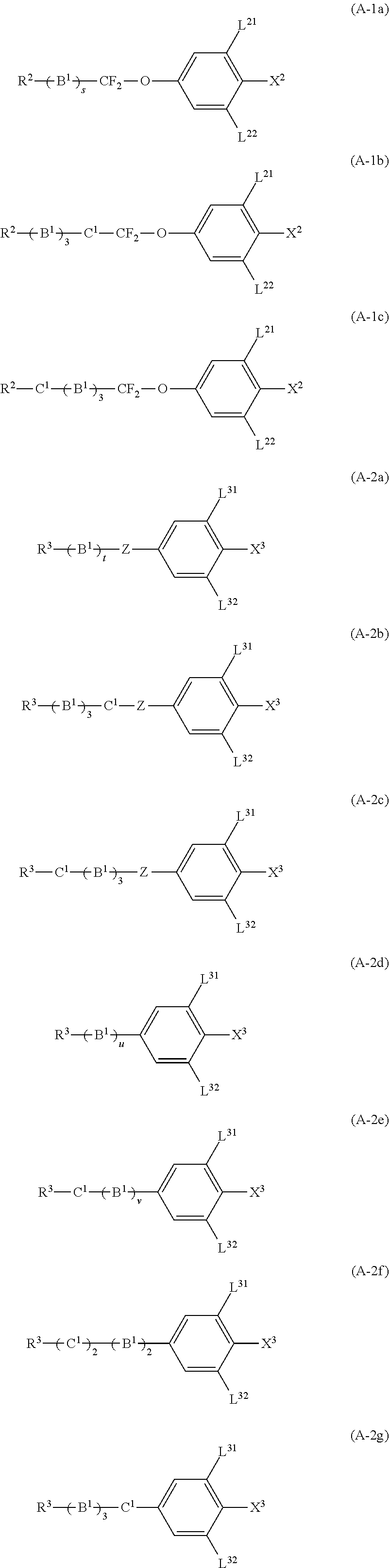
wherein R² and R³ are each independently a C1-C7 alkyl, alkoxy, fluorinated alkyl, or fluorinated alkoxy group, or a C2-C7 alkenyl, alkenyloxy, alkoxyalkyl, or fluorinated alkenyl group; B¹ is any one of groups represented by the following formulas (b11) to (b15); C¹ is any one of groups represented by the following formulas (c11) to (c24); L²¹, L²², L³¹, and L³² are each independently a hydrogen atom or a fluorine atom; X² and X³ are each independently a halogen atom, a C1-C3 halogenated alkyl or alkoxy group, or a C2-C3 halogenated alkenyl or alkenyloxy group; Z is —CH₂CH₂—, —CF₂CF₂—, —COO—, trans-CH═CH—, trans-CF═CF—, or —CH₂O—; s and t are each independently 3 or 4; and u and v are each independently 2 or 3, 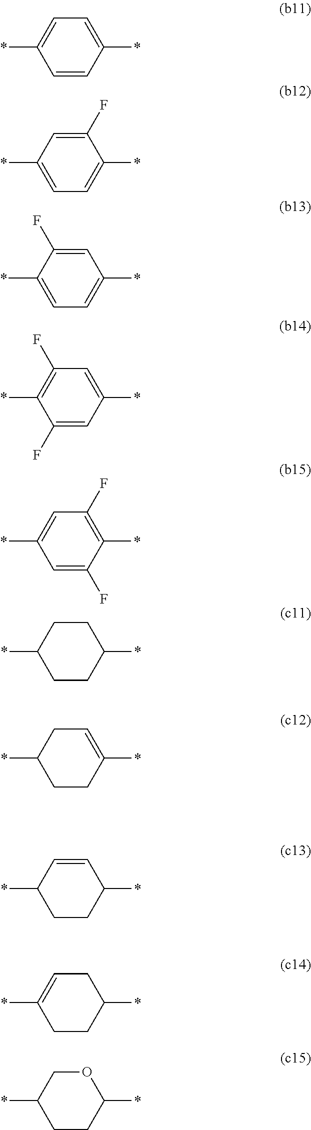 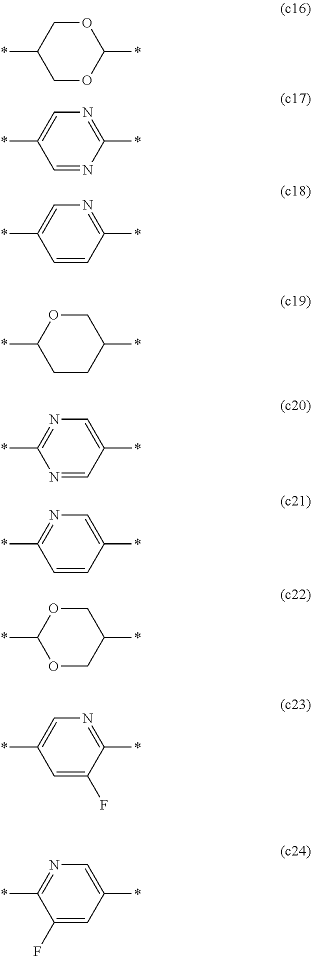
wherein * is a binding site.

5. The liquid crystal display device according to claim 1,
wherein the alignment film contains at least one selected from a cinnamate group and a chalcone group.

6. The liquid crystal display device according to claim 1,
wherein the heteroaromatic group contains a heterocycle that contains a secondary amino group.

7. The liquid crystal display device according to claim 1,
wherein the heteroaromatic group is at least one selected from the group consisting of an indole group, a benzimidazole group, a purine group, a phenoxazine group, and a phenothiazine group.

8. The liquid crystal display device according to claim 1,
wherein the alignment film has at least one polymer main chain structure selected from the group consisting of a polyamic acid structure, a polyimide structure, a polysiloxane structure, and a polyvinyl structure.
